(19) United States
(12) Patent Application Publication
(10) Pub. No.: US 2025/0219779 A1
(43) Pub. Date: Jul. 3, 2025

(54) BEACON EXTENSION DESIGN

(71) Applicant: QUALCOMM Incorporated, San Diego, CA (US)

(72) Inventors: Abhishek Pramod PATIL, San Diego, CA (US); Gaurang NAIK, San Diego, CA (US); Sai Yiu Duncan HO, San Diego, CA (US); George CHERIAN, San Diego, CA (US); Alfred ASTERJADHI, San Diego, CA (US); Sherief HELWA, San Diego, CA (US); Giovanni CHISCI, San Diego, CA (US); Sanket Sanjay KALAMKAR, San Diego, CA (US); Guido Robert FREDERIKS, Watsonville, CA (US)

(21) Appl. No.: 18/999,573

(22) Filed: Dec. 23, 2024

Related U.S. Application Data
(60) Provisional application No. 63/614,990, filed on Dec. 27, 2023.

(51) Int. Cl. H04L 5/00; H04L 67/00; H04W 28/18

(52) U.S. Cl. CPC H04L 5/0048; H04L 67/34; H04W 28/18

(57) ABSTRACT

This disclosure provides methods, components, devices and systems for beacon extension design. A wireless station may receive one or more beacon containers including a beacon extension container and may communicate one or more messages based on segments of the one or more beacon containers that are relevant for the wireless station. Each segment may correspond to a respective device type. Each segment may include a frame check sequence and a message integrity code corresponding to each respective segment. The wireless station may receive a first beacon container according to a first periodicity and a second beacon container according to a second periodicity. The first and second periodicities may have different values based on the device type of the wireless station. The beacon containers may include type-specific segments corresponding to the device type. Each type-specific segment may include parameters or updated information for the wireless station.

### CROSS REFERENCE

The present Application for Patent claims the benefit of Provisional Patent Application No. 63/614,990 by PATIL et al., entitled “BEACON EXTENSION DESIGN,” filed Dec. 27, 2023, assigned to the assignee hereof and hereby expressly incorporated by reference herein.

### TECHNICAL FIELD

This disclosure relates generally to wireless communication and, more specifically, to beacon extension design. A wireless station may receive one or more beacon containers including a beacon extension container and may communicate one or more messages based on segments of the one or more beacon containers that are relevant for the wireless station.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a first wireless device for wireless communications. The first wireless device may include a processing system that includes processor circuitry and memory circuitry that stores code. The processing system may be configured to cause the first wireless device to receive, from a second wireless device, a first message container that includes a first set of one or more type-specific segments, a first type-specific segment of the first set of one or more type-specific segments including a first set of one or more type-specific parameters, receive, from the second wireless device, a second message container that includes a second set of one or more type-specific segments, where the first type-specific segment and a second type-specific segment of the second set of one or more type-specific segments both correspond to a device type of the first wireless device, and communicate one or more messages with the second wireless device in accordance with the first type-specific segment and the second type-specific segment.

Another innovative aspect of the subject matter described in this disclosure can be implemented in a method for wireless communications by a first wireless device. The method may include receiving, from a second wireless device, a first message container that includes a first set of one or more type-specific segments, a first type-specific segment of the first set of one or more type-specific segments including a first set of one or more type-specific parameters, receiving, from the second wireless device, a second message container that includes a second set of one or more type-specific segments, where the first type-specific segment and a second type-specific segment of the second set of one or more type-specific segments both correspond to a device type of the first wireless device, and communicating one or more messages with the second wireless device in accordance with the first type-specific segment and the second type-specific segment.

Another innovative aspect of the subject matter described in this disclosure can be implemented in another first wireless device for wireless communications. The first wireless device may include means for receiving, from a second wireless device, a first message container that includes a first set of one or more type-specific segments, a first type-specific segment of the first set of one or more type-specific segments including a first set of one or more type-specific parameters, means for receiving, from the second wireless device, a second message container that includes a second set of one or more type-specific segments, where the first type-specific segment and a second type-specific segment of the second set of one or more type-specific segments both correspond to a device type of the first wireless device, and means for communicating one or more messages with the second wireless device in accordance with the first type-specific segment and the second type-specific segment.

Another innovative aspect of the subject matter described in this disclosure can be implemented in a non-transitory computer-readable medium storing code for wireless communications. The code may include instructions executable by one or more processors to receive, from a second wireless device, a first message container that includes a first set of one or more type-specific segments, a first type-specific segment of the first set of one or more type-specific segments including a first set of one or more type-specific parameters, receive, from the second wireless device, a second message container that includes a second set of one or more type-specific segments, where the first type-specific segment and a second type-specific segment of the second set of one or more type-specific segments both correspond to a device type of the first wireless device, and communicate one or more messages with the second wireless device in accordance with the first type-specific segment and the second type-specific segment.

In some examples of the method, first wireless devices, and non-transitory computer-readable medium described herein, the first message container and the second message container may be received via a primary channel.

In some examples of the method, first wireless devices, and non-transitory computer-readable medium described herein, a single physical layer protocol data unit (PPDU) includes the first message container and the second message container.

In some examples of the method, first wireless devices, and non-transitory computer-readable medium described herein, a first physical layer protocol data unit (PPDU) includes the first message container and a second PPDU includes the second message container.

In some examples of the method, first wireless devices, and non-transitory computer-readable medium described herein, the first type-specific segment includes information to configure the device type of the first wireless device and one or more generations of device types prior to the device type and the second type-specific segment includes information to configure the device type of the first wireless device.

In some examples of the method, first wireless devices, and non-transitory computer-readable medium described herein, the second type-specific segment indicates an update to at least one parameter of the first set of one or more type-specific parameters.

In some examples of the method, first wireless devices, and non-transitory computer-readable medium described herein, the first type-specific segment, the second type-specific segment, or both, include an information element, a field, or both.

In some examples of the method, first wireless devices, and non-transitory computer-readable medium described herein, the second set of one or more type-specific segments included in the second message container includes a type-specific segment having a value that may have changed since reception of the first message container.

In some examples of the method, first wireless devices, and non-transitory computer-readable medium described herein, receiving the first message container may include operations, features, means, or instructions for receiving the first message container including an indication that indicates that at least a first portion of the first set of one or more type-specific parameters may be included in the first message container, that at least a second portion of the first set of one or more type-specific parameters may be included in the second message container, or both, where the indication may be based on the device type of the first wireless device.

Some examples of the method, first wireless devices, and non-transitory computer-readable medium described herein may further include operations, features, means, or instructions for receiving, in accordance with a first periodicity, a set of one or more first message containers and receiving, in accordance with a second periodicity, a set of one or more second message containers, where the second periodicity may be greater than the first periodicity.

Some examples of the method, first wireless devices, and non-transitory computer-readable medium described herein may further include operations, features, means, or instructions for receiving, in accordance with a first periodicity, a set of one or more first message containers each including one or more common parameters and receiving, in accordance with a second periodicity, a set of one or more second message containers each including a second set of one or more type-specific parameters, where the second set of one or more type-specific parameters corresponds to the device type of the first wireless device.

Another innovative aspect of the subject matter described in this disclosure can be implemented in a second wireless device for wireless communications. The second wireless device may include a processing system that includes processor circuitry and memory circuitry that stores code. The processing system may be configured to cause the second wireless device to transmit, to a first wireless device, a first message container that includes a first set of one or more type-specific segments, a first type-specific segment of the first set of one or more type-specific segments including a first set of one or more type-specific parameters, transmit, to the first wireless device, a second message container that includes a second set of one or more type-specific segments, where the first type-specific segment and a second type-specific segment of the second set of one or more type-specific segments both correspond to a device type of the first wireless device, and communicate one or more messages with the first wireless device in accordance with the first type-specific segment and the second type-specific segment.

Another innovative aspect of the subject matter described in this disclosure can be implemented in a method for wireless communications by a second wireless device. The method may include transmitting, to a first wireless device, a first message container that includes a first set of one or more type-specific segments, a first type-specific segment of the first set of one or more type-specific segments including a first set of one or more type-specific parameters, transmitting, to the first wireless device, a second message container that includes a second set of one or more type-specific segments, where the first type-specific segment and a second type-specific segment of the second set of one or more type-specific segments both correspond to a device type of the first wireless device, and communicating one or more messages with the first wireless device in accordance with the first type-specific segment and the second type-specific segment.

Another innovative aspect of the subject matter described in this disclosure can be implemented in another second wireless device for wireless communications. The second wireless device may include means for transmitting, to a first wireless device, a first message container that includes a first set of one or more type-specific segments, a first type-specific segment of the first set of one or more type-specific segments including a first set of one or more type-specific parameters, means for transmitting, to the first wireless device, a second message container that includes a second set of one or more type-specific segments, where the first type-specific segment and a second type-specific segment of the second set of one or more type-specific segments both correspond to a device type of the first wireless device, and means for communicating one or more messages with the first wireless device in accordance with the first type-specific segment and the second type-specific segment.

Another innovative aspect of the subject matter described in this disclosure can be implemented in a non-transitory computer-readable medium storing code for wireless communications. The code may include instructions executable by one or more processors to transmit, to a first wireless device, a first message container that includes a first set of one or more type-specific segments, a first type-specific segment of the first set of one or more type-specific segments including a first set of one or more type-specific parameters, transmit, to the first wireless device, a second message container that includes a second set of one or more type-specific segments, where the first type-specific segment and a second type-specific segment of the second set of one or more type-specific segments both correspond to a device type of the first wireless device, and communicate one or more messages with the first wireless device in accordance with the first type-specific segment and the second type-specific segment.

In some examples of the method, second wireless devices, and non-transitory computer-readable medium described herein, the first message container and the second message container may be transmitted via a primary channel.

In some examples of the method, second wireless devices, and non-transitory computer-readable medium described herein, a single physical layer protocol data unit (PPDU) includes the first message container and the second message container.

In some examples of the method, second wireless devices, and non-transitory computer-readable medium described herein, a first physical layer protocol data unit (PPDU) includes the first message container and a second PPDU includes the second message container.

In some examples of the method, second wireless devices, and non-transitory computer-readable medium described herein, the first type-specific segment includes information to configure the device type of the first wireless device and one or more generations of device types prior to the device type and the second type-specific segment includes information to configure the device type of the first wireless device.

In some examples of the method, second wireless devices, and non-transitory computer-readable medium described herein, the second type-specific segment indicates an update to at least one parameter of the first set of one or more type-specific parameters.

In some examples of the method, second wireless devices, and non-transitory computer-readable medium described herein, the first type-specific segment, the second type-specific segment, or both, include an information element, a field, or both.

In some examples of the method, second wireless devices, and non-transitory computer-readable medium described herein, the second set of one or more type-specific segments included in the second message container a type-specific segment having a value that may have changed since transmission of the first message container.

Some examples of the method, second wireless devices, and non-transitory computer-readable medium described herein may further include operations, features, means, or instructions for transmitting, in accordance with a first periodicity, a set of one or more first message containers and transmitting, in accordance with a second periodicity, a set of one or more second message containers, where the second periodicity may be greater than the first periodicity.

Some examples of the method, second wireless devices, and non-transitory computer-readable medium described herein may further include operations, features, means, or instructions for transmitting, in accordance with a first periodicity, a set of one or more first message containers each including one or more common parameters and transmitting, in accordance with a second periodicity, a set of one or more second message containers each including a second set of one or more type-specific parameters, where the second set of one or more type-specific parameters corresponds to the device type of the first wireless device.

In some examples of the method, second wireless devices, and non-transitory computer-readable medium described herein, the second wireless device may be an access point.

Another innovative aspect of the subject matter described in this disclosure can be implemented in a first wireless device for wireless communications. The first wireless device may include a processing system that includes processor circuitry and memory circuitry that stores code. The processing system may be configured to cause the first wireless device to receive, from a second wireless device, a message extension container that includes one or more segments, the one or more segments including a common segment with one or more common parameters and a set of one or more type-specific segments, each type-specific segment of the set of one or more type-specific segments including a respective set of one or more type-specific parameters that correspond to a respective device type of a set of multiple device types and communicate one or more messages with the second wireless device in accordance with the one or more common parameters and a first set of one or more type-specific parameters from a first type-specific segment from the one or more segments that corresponds to a device type of the first wireless device.

Another innovative aspect of the subject matter described in this disclosure can be implemented in a method for wireless communications by a first wireless device. The method may include receiving, from a second wireless device, a message extension container that includes one or more segments, the one or more segments including a common segment with one or more common parameters and a set of one or more type-specific segments, each type-specific segment of the set of one or more type-specific segments including a respective set of one or more type-specific parameters that correspond to a respective device type of a set of multiple device types and communicating one or more messages with the second wireless device in accordance with the one or more common parameters and a first set of one or more type-specific parameters from a first type-specific segment from the one or more segments that corresponds to a device type of the first wireless device.

Another innovative aspect of the subject matter described in this disclosure can be implemented in another first wireless device for wireless communications. The first wireless device may include means for receiving, from a second wireless device, a message extension container that includes one or more segments, the one or more segments including a common segment with one or more common parameters and a set of one or more type-specific segments, each type-specific segment of the set of one or more type-specific segments including a respective set of one or more type-specific parameters that correspond to a respective device type of a set of multiple device types and means for communicating one or more messages with the second wireless device in accordance with the one or more common parameters and a first set of one or more type-specific parameters from a first type-specific segment from the one or more segments that corresponds to a device type of the first wireless device.

Another innovative aspect of the subject matter described in this disclosure can be implemented in a non-transitory computer-readable medium storing code for wireless communications. The code may include instructions executable by one or more processors to receive, from a second wireless device, a message extension container that includes one or more segments, the one or more segments including a common segment with one or more common parameters and a set of one or more type-specific segments, each type-specific segment of the set of one or more type-specific segments including a respective set of one or more type-specific parameters that correspond to a respective device type of a set of multiple device types and communicate one or more messages with the second wireless device in accordance with the one or more common parameters and a first set of one or more type-specific parameters from a first type-specific segment from the one or more segments that corresponds to a device type of the first wireless device.

In some examples of the method, first wireless devices, and non-transitory computer-readable medium described herein, communicating the one or more messages may include operations, features, means, or instructions for communicating the one or more messages with the access point in accordance with a second set of one or more type-specific parameters from one or more second type-specific segments from the one or more segments, the one or more second type-specific segments based on the device type of the first wireless device.

In some examples of the method, first wireless devices, and non-transitory computer-readable medium described herein, receiving the message extension container may include operations, features, means, or instructions for receiving the message extension container including a set of multiple frame check sequences, where each segment of the one or more segments includes a respective frame check sequence of the set of multiple frame check sequences.

In some examples of the method, first wireless devices, and non-transitory computer-readable medium described herein, receiving the message extension container may include operations, features, means, or instructions for receiving the message extension container including a set of multiple message integrity codes, where each segment of the one or more segments includes a respective message integrity code of the set of multiple message integrity codes.

Another innovative aspect of the subject matter described in this disclosure can be implemented in a second wireless device for wireless communications. The second wireless device may include a processing system that includes processor circuitry and memory circuitry that stores code. The processing system may be configured to cause the second wireless device to transmit, to a first wireless device, a message extension container that includes one or more segments, the one or more segments including a common segment with one or more common parameters and a set of one or more type-specific segments, each type-specific segment of the set of one or more type-specific segments including a respective set of one or more type-specific parameters that correspond to a respective device type of a set of multiple device types and communicate one or more messages with the first wireless device in accordance with the one or more common parameters and a first set of one or more type-specific parameters from a first type-specific segment from the one or more segments that corresponds to a device type of the first wireless device.

Another innovative aspect of the subject matter described in this disclosure can be implemented in a method for wireless communications by a second wireless device. The method may include transmitting, to a first wireless device, a message extension container that includes one or more segments, the one or more segments including a common segment with one or more common parameters and a set of one or more type-specific segments, each type-specific segment of the set of one or more type-specific segments including a respective set of one or more type-specific parameters that correspond to a respective device type of a set of multiple device types and communicating one or more messages with the first wireless device in accordance with the one or more common parameters and a first set of one or more type-specific parameters from a first type-specific segment from the one or more segments that corresponds to a device type of the first wireless device.

Another innovative aspect of the subject matter described in this disclosure can be implemented in another second wireless device for wireless communications. The second wireless device may include means for transmitting, to a first wireless device, a message extension container that includes one or more segments, the one or more segments including a common segment with one or more common parameters and a set of one or more type-specific segments, each type-specific segment of the set of one or more type-specific segments including a respective set of one or more type-specific parameters that correspond to a respective device type of a set of multiple device types and means for communicating one or more messages with the first wireless device in accordance with the one or more common parameters and a first set of one or more type-specific parameters from a first type-specific segment from the one or more segments that corresponds to a device type of the first wireless device.

Another innovative aspect of the subject matter described in this disclosure can be implemented in a non-transitory computer-readable medium storing code for wireless communications. The code may include instructions executable by one or more processors to transmit, to a first wireless device, a message extension container that includes one or more segments, the one or more segments including a common segment with one or more common parameters and a set of one or more type-specific segments, each type-specific segment of the set of one or more type-specific segments including a respective set of one or more type-specific parameters that correspond to a respective device type of a set of multiple device types and communicate one or more messages with the first wireless device in accordance with the one or more common parameters and a first set of one or more type-specific parameters from a first type-specific segment from the one or more segments that corresponds to a device type of the first wireless device.

In some examples of the method, second wireless devices, and non-transitory computer-readable medium described herein, communicating the one or more messages may include operations, features, means, or instructions for communicating the one or more messages with the first wireless device in accordance with a second set of one or more type-specific parameters from one or more second type-specific segments from the one or more segments, the one or more second type-specific segments based on the device type of the first wireless device.

In some examples of the method, second wireless devices, and non-transitory computer-readable medium described herein, transmitting the message extension container may include operations, features, means, or instructions for transmitting the message extension container including a set of multiple frame check sequences, where each segment of the one or more segments includes a respective frame check sequence of the set of multiple frame check sequences.

In some examples of the method, second wireless devices, and non-transitory computer-readable medium described herein, receiving the message extension container may include operations, features, means, or instructions for transmitting the message extension container including a set of multiple message integrity codes, where each segment of the one or more segments includes a respective message integrity code of the set of multiple message integrity codes.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows a frequency diagram depicting an example distributed tone mapping.

FIG. 6 shows an example of a signaling diagram that supports beacon extension design.

FIG. 7 shows an example of a beacon frame diagram that supports beacon extension design.

FIG. 8 shows an example of a message container diagram that supports beacon extension design.

FIG. 9 shows an example of a signal timing diagram that supports beacon extension design.

FIG. 10 shows an example of a signal timing diagram that supports beacon extension design.

FIG. 11 shows an example of a signal timing diagram that supports beacon extension design.

FIG. 12 shows an example of a message container diagram that supports beacon extension design.

FIGS. 13 and 14 show examples of process flows that support beacon extension design.

FIG. 15 shows a block diagram of an example wireless communication device that supports beacon extension design.

FIG. 16 shows a block diagram of an example wireless communication device that supports beacon extension design.

FIGS. 17 and 18 show flowcharts illustrating example processes performable by or at a first wireless device that supports beacon extension design.

FIG. 19 shows a flowchart illustrating an example process performable by or at a second wireless device that supports beacon extension design.

FIG. 20 shows a flowchart illustrating an example process performable by or at a first wireless device that supports beacon extension design.

FIG. 21 shows a flowchart illustrating an example process performable by or at a second wireless device that supports beacon extension design.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to a wireless station that may receive one or more message containers including a beacon frame and a beacon extension frame and may communicate one or more messages based on segments of the one or more message containers that are relevant for the wireless station. A message container may refer to data that is organized in a particular format for transmission. An example of a message container is a frame (such as a frame that complies with the IEEE 802.11 family of wireless communication protocol standards, a physical layer (PHY) protocol data unit (PPDU), or the like. Some aspects more specifically relate to one or more segments of a message container, each segment corresponding to a respective device type (or a generation of devices). Each segment may include a frame check sequence (FCS) and a message integrity code (MIC) corresponding to each respective segment. In some implementations, the wireless station may parse a subset of the one or more segments, including a common segment used for multiple device types and type-specific segments that correspond to a device type of the wireless station. The wireless station also may perform error detection and integrity checks for each segment.

Some aspects relate further to the wireless station receiving a set of message containers including a first message container (such as a beacon frame) according to a first periodicity and a second message container (such as a beacon extension frame or a follow up frame) according to a second periodicity. In some implementations, the beacon extension may be an example of a second message container that may offload information from a first message container (such as a legacy beacon frame). The first and second periodicities may have different values based on the device type of the wireless station. Each message container may include a respective set of segments. The first message container may include one or more type-specific parameters in a type-specific segment corresponding to the device type. A type-specific parameter may refer to information that configures a device of that device type, and optionally that configures one or more subsequent generations of device types, to perform a particular operation (such as one or more parameters for configuring a device that complies with an ultra-high reliability (UHR) IEEE standard).

The second message container may include an update to the type-specific parameters in a second type-specific segment corresponding to the device type. Although the first and second message containers may be described as beacon frames, beacon extension frames, similar beacon containers, or a combination thereof, it is noted that the techniques described herein may be applied to any container (such as any frame or message container) that includes information which may be separated into segments of information, each segment associated with a different category or type of receiver (such as wireless stations having different device types or generations). In some implementations, the first message container, the second message container, or both may be examples of a probe response frame (such as a broadcast probe response frame in response to a probe request frame), a (Re) Association Response frame, a management frame (such as a new public action frame), or a probe response frame sent via a type-specific PPDU (such as a PPDU formatted according to a UHR PPDU format).

Particular aspects of the subject matter described in this disclosure can be implemented to realize one or more of the following potential advantages. In some implementations, by parsing relevant segments of the one or more message containers, the described techniques can be used to allow a wireless station to save processing power, reduce the memory require to store the contents, and reduce the computational effort needed to process large amount of data (to generate MIC/FCS). Further, the wireless station may receive communication parameters while avoiding message container sizes (such as beacon frame sizes) which exceed a configured threshold length and may communicate according to the communication parameters.

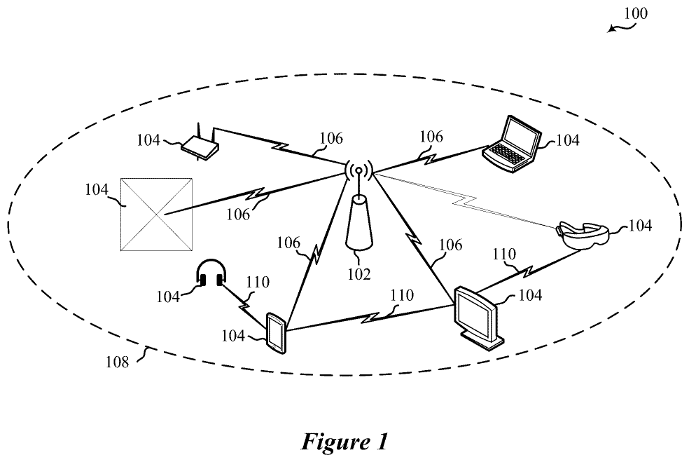

In the following descriptions of FIGS. 1-21, it is noted that processes described to be performed by an AP and a STA may be performed by one or more STAs (such as non-AP STAs), one or more APs, or any combination thereof. For example, a non-AP STA may transmit a message container or a frame (such as a broadcast probe request frame) which is received by multiple APs in a neighborhood (or a network) belonging to different generations (or device types). In some implementations, techniques described herein may be applied, for example, to reduce the amount of processing power at the receiving APs or to reduce the size of the probe request frame. That is, although the following descriptions describe an AP that transmits one or more message containers (such as beacon frames), the techniques described herein may be applied where a non-AP STA transmits one or more messages containers (which may include beacon frames or other containers such as broadcast probe request frames or other frames).

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. The terms “wireless communication device” and “wireless device” may be used interchangeably and may be encompassing of a wireless station (STA) 104, a wireless access point (AP) 102, or both.

The wireless communication network 100 may include numerous wireless communication devices including at least one AP 102 and any number of STAs 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some implementations, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use implementations associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHZ-24.25 GHZ), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHZ, 320 MHz, 480 MHz, or 640 MHz by bonding together multiple 20 MHz channels.

Further, as described herein, the terms “channel” and “subchannel” may be used interchangeably, and each may refer to a portion of a frequency spectrum via which communication between two or more wireless communication devices can be allocated. For example, a channel or subchannel may refer to a discrete portion (such as a discrete amount, span, range, or subset) of frequency of an operating bandwidth. A channel or subchannel may refer to a 20 MHz portion, a 40 MHz portion, an 80 MHz portion, or a 160 MHz portion, among other examples. In other words, a channel or subchannel may include one or more 20 MHz channels. A primary channel or subchannel may be understood as a portion of a frequency spectrum that includes a primary 20 MHz used for beaconing, among other (management) frame transmissions. A secondary channel or subchannel may be understood as a portion of a frequency spectrum that excludes the primary 20 MHz (or that at least excludes a main primary (M-Primary) channel). In some systems, a secondary channel or subchannel may include an opportunistic primary (O-Primary) channel. A wireless communication device may use an M-Primary channel (such as an M-Primary 20 MHz) for beaconing and/or serving legacy clients and may use an O-Primary channel (such as an O-Primary 20 MHz) for opportunistic access on one or more other channels (such as if the M-Primary channel is busy or occupied).

In some aspects, different portions of a frequency spectrum (such as a 40 MHz portion, an 80 MHz portion, or a 160 MHz portion) may be associated with multiple (20 MHz) subchannels and at least one anchor subchannel. In such aspects, an anchor subchannel may define, indicate, or identify a lowest (20 MHz) subchannel within a given portion of a frequency spectrum. For example, a first anchor subchannel may define, indicate, or identify a lowest 20 MHz subchannel within a secondary 40 MHz bandwidth, a second anchor subchannel may define, indicate, or identify a lowest 20 MHz subchannel within a secondary 80 MHz bandwidth, and a third anchor subchannel may define, indicate, or identify a lowest 20 MHz subchannel within a secondary 160 MHz bandwidth. In some aspects, a wireless communication device may use an anchor subchannel as an O-Primary channel.

In some wireless communications networks, an AP may transmit a beacon to one or more STAs in a BSS. The beacon may serve one or more roles in the operation of the BSS. For example, the beacon may include timing information (such as a TSF). The timing information may provide a common clock across each STA in a BSS. The beacon may include a traffic indication that indicates to one or more STAs that the AP has buffered traffic for the one or more STAs. Additionally, or alternatively, the beacon may indicate capabilities and operational attributes of the AP and may include a mechanism for indicating critical updates for one or more BSS parameters.

A set of one or more STAs having different device types (such as belonging to different generations) may each process the beacon from the AP. For example, a beacon from an AP belonging to one generation (such as an extremely high throughput (EHT) AP) may be processed by STAs (such as non-AP STAs) in the wireless communications network that belong to other generations or device types (such as 11a, 11b, 11g, 11n, 11ac, 11ax or 11be generation). Each STA of the set of one or more STAs may determine that an AP is supporting its generation based on the information elements (IEs) (such as Capabilities element and/or Operation element for that generation) carried in the beacon (such as in a beacon frame). For example, a STA of the set of one or more STAs may determine that the AP supports its generation based on a presence of IEs indicating capabilities and operation in the Beacon frame of the AP.

In some implementations, a device type may be interpreted as or may refer to a particular generation of wireless device, a group of devices from a particular release, or any combination thereof. In some implementations, a device type (such as each generation of Wi-Fi devices) may have a defined set of IEs that carry information (such as capability or operation information or other parameters) relevant to the device type. An AP (such as an EHT AP), based on capabilities of the AP, may transmit the elements belonging to its device type or generation (such as EHT) along with elements defined by previous device types or generations (such as from the 802.11 family of standards, including 11a, 11b, 11g, 11n, 11ac, 11ax or 11be generation) as part of a beacon frame of the AP. Thus, adding information for device types may cause the beacon frame to be relatively large (such as exceeding 2000 octets).

In some wireless communications networks, some devices (such as relatively older generation devices) may parse beacons whose size does not exceed a size threshold. For example, the devices may expect a beacon size to not exceed a certain length. The size threshold may vary among device types (such as between 1500 and 1800 bytes). A device that encounters a beacon beyond the threshold size (or length) may be unable to parse the full beacon which may lead to a variety of issues. For example, if a STA (such as a STA from a relatively old generation or device type) is unable to parse the full beacon, the STA may be unable to discover capability information and operation parameters of the AP, and thus the STA may be unlikely to communicate properly with the AP. If the AP includes additional elements (such as due to critical updates or the like) that cause the beacon length to cross the threshold size, the STA may incorrectly conclude that a link with the AP is lost. In some implementations, the STA may disassociate itself with the AP, which may be disruptive to ongoing traffic flows. The STA may begin transmitting probes to discover and reassociate with the AP, which may lead to increased management frame overhead. In some implementations, if the STA fails to parse the full beacon, the STA may “blacklist” the AP and refrain from attempting to associate with the AP.

Further, the beacon may include a frame check sequence (FCS) subsequent to other information in the beacon frame (such as IEs relevant to device types and operations). In some implementations, the STA may validate the FCS after successfully parsing the other information in the beacon frame. In such implementations, the STA may inefficiently use resources (such as processing and power) by parsing segments of the beacon frame that include information which is irrelevant to the device type of the STA. For example, a first STA with a first device type (such as a very high throughput (VHT) non-AP STA) associated with an AP with a second device type (such as an ultra-high reliability (UHR) AP) may parse information relevant to the second device type, and potentially relevant to multiple other device types (such as high efficiency (HE), EHT, and UHR IEs) before validating the FCS. Thus, the first STA may inefficiently use processing and power each time it receives a beacon (such as every 100 ms).

The wireless communications network 100 may include a STA 104 that may receive a frame (such as a beacon extension frame or a follow-up frame) that carries one or more IEs (such as IEs normally present in a beacon). For example, the AP 102 may offload some elements (such as IEs defined by a particular device type) of a beacon frame to be carried in a separate frame (such as the beacon extension frame). The wireless communications network 100 may provide for transmitting a beacon frame and a beacon extension frame that accounts for threshold sizes associated with some device types. Further, the wireless communications network 100 may provide flexibility such that a STA 104 may parse (or process) only a portion of the frame (such as the portion of the frame that is relevant to a device type of the STA 104). For example, the STA 104 may parse fields, segments, or IEs that are associated with the device type of the STA 104, but may refrain from parsing fields, segments, or IEs that are associated with other device types (such as IEs relevant to generations of devices which are newer than the STA 104). As described herein, a beacon extension frame may refer to a follow-up frame, a message container, or any combination thereof.

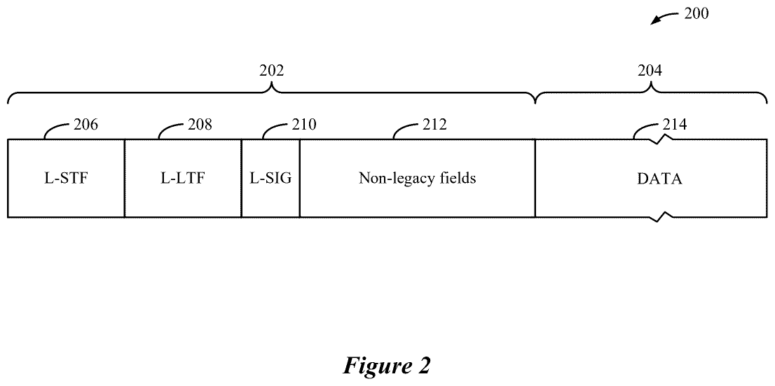

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

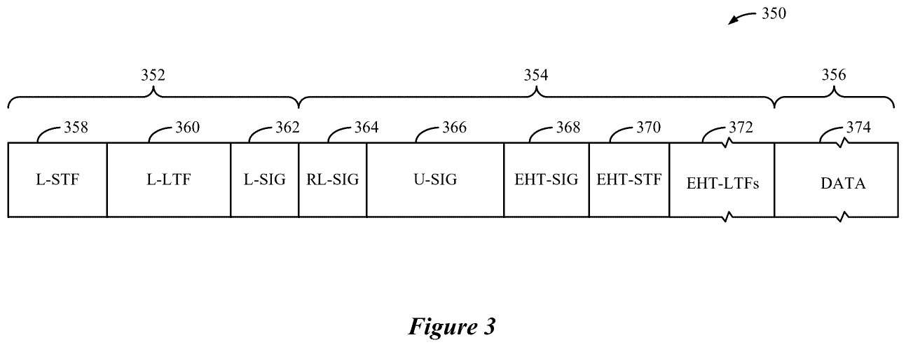

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as the AP 102 or the STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include resource unit (RU) allocation information, spatial stream configuration information, and per-user (for example, STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

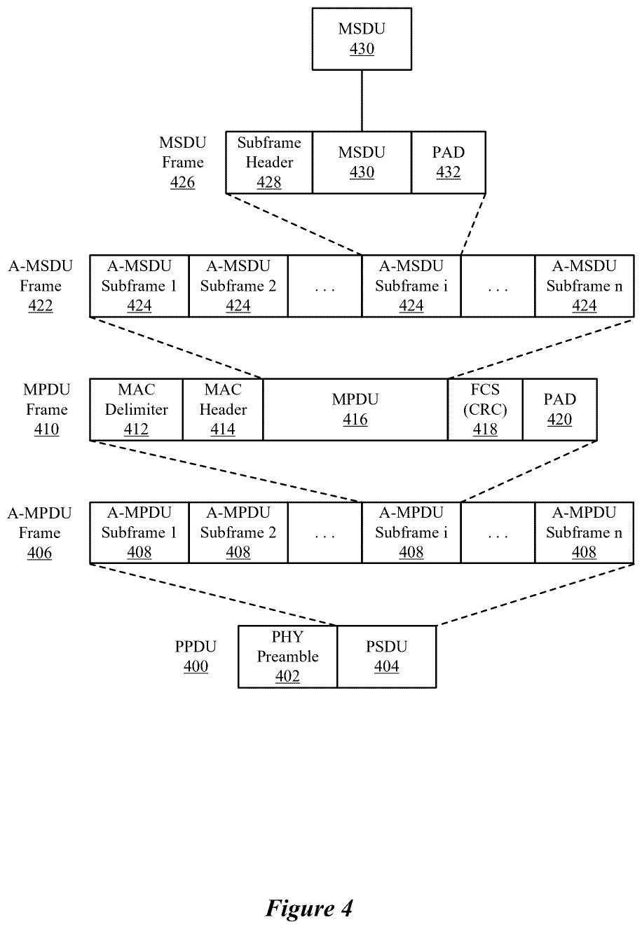

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include an FCS field 418 for error detection (for example, the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with (such as an example of or otherwise referred to as) an MSDU frame 426 and may contain a corresponding MSDU 430 preceded by a subframe header 428 and, in some examples, followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame (such as a public action frame).

Some APs and STAs (for example, the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from overlapping BSS (OBSS) interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some implementations, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

In some environments, locations, or conditions, a regulatory body may impose a power spectral density (PSD) limit for one or more communication channels or for an entire band (for example, the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (for example, duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or multiple RU (MRU) tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

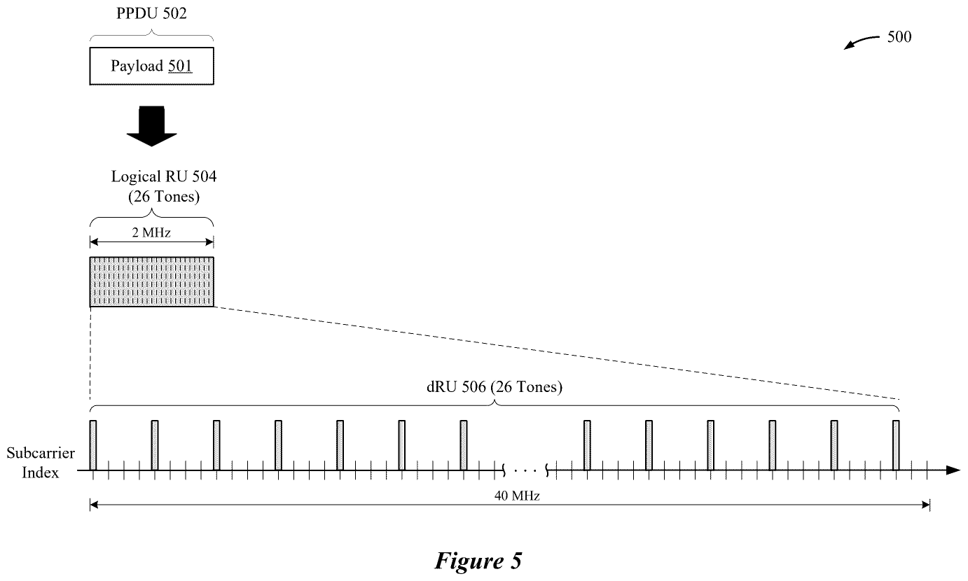

FIG. 5 shows a frequency diagram 500 depicting an example distributed tone mapping. More specifically, FIG. 5 shows an example mapping of how the tones of a payload 501 of a PPDU 502 are distributed for transmission over a spreading bandwidth of a wireless channel. In the illustrated example, the tones in a logical RU 504 (which may represent an rRU of non-distributed tones in accordance with a legacy tone plan) associated with payload 501 are mapped to a distributed RU (dRU) 506 in accordance with a distributed tone plan.

Aspects of the present disclosure recognize that by distributing the tones across a wider bandwidth, the per-tone transmit power of a logical RU 504 may be increased to provide greater flexibility in medium utilization for PSD-limited wireless channels. For example, when mapped to an rRU such as logical RU 504, the transmit power of the logical RU 504 may be severely limited based on the PSD of the wireless channel. For example, the LPI power class limits the transmit power of APs 102 and STAs 104 to 5 dBm/MHz and −1 dBm/MHz, respectively, in the 6 GHz band. As such, the per-tone transmit power of the logical RU 504 is limited by the number of tones mapped to each 1 MHz subchannel of the wireless channel.

By enabling a STA 104 to map modulation symbols in a distributed manner onto noncontiguous tones interspersed throughout all or a portion of a wireless channel, distributed transmissions may enable an increase in the per-tone transmit power used for each individual distributed tone, and thus the overall transmit power of the PPDU 502, without exceeding the PSD limits of the wireless channel. As shown in the example of FIG. 5, the STA 104 may map logical RU 504 to a set of 26 noncontiguous subcarrier indices spread across a 40 MHz wireless channel (also referred to herein as an exemplary “spreading bandwidth”). Compared to the tone mapping described above with respect to the legacy tone plan, the distributed tone mapping depicted in FIG. 5 effectively reduces the number of tones (of the logical RU 504) in each 1 MHz subchannel. For example, each of the 26 tones can be mapped to a different 1 MHz subchannel of the 40 MHz channel. As a result, each AP 102 or STA 104 implementing the distributed tone mapping of FIG. 5 can maximize its per-tone transmit power (which may maximize the overall transmit power of the logical RU 504).

In some examples (not shown in FIG. 5), multiple logical RUs may be mapped to interleaved subcarrier indices of a shared wireless channel. For example, a STA 104 may modulate a portion of the symbols on a number of tones representing multiple logical RUs to noncontiguous subcarrier indices associated with a shared wireless channel in accordance with a distributed tone plan. Furthermore, distributed transmissions by multiple STAs 104 may be multiplexed onto different sets of distributed tones of a shared wireless channel such as to enable an increase in the transmit power of each device without sacrificing spectral efficiency. Such increases in transmit power can be combined with some MCSs to increase the range and throughput of wireless communications on PSD-limited wireless channels. Distributed transmissions also may improve packet detection and channel estimation capabilities.

To support distributed transmissions, new packet designs and signaling may be used to indicate whether a PPDU 502 is transmitted on tones spanning an rRU, such as a logical RU 504 (according to a legacy tone plan), or a dRU 506 (according to a distributed tone plan). For example, the IEEE 802.11be standard amendment or earlier versions of the IEEE 802.11 family of wireless communication protocol standards define a trigger frame format which can be used to solicit the transmission of a trigger-based (TB) PPDU from one or more STAs 104. The trigger frame allocates resources to the STAs 104 for the transmission of the TB PPDU and indicates how the TB PPDU is to be configured for transmission. For example, the trigger frame may indicate a logical RU or MRU allocated for transmission in the TB PDDU. In some implementations, the trigger frame may be further configured to carry tone distribution information indicating whether the logical RU (or MRU) maps to an rRU or a dRU.

In some implementations, a STA 104 may include a distributed tone mapper that maps the logical RU 504 to the dRU 506 in the frequency domain. The dRU 506 is converted to a time-domain signal (such as by an inverse fast Fourier transform) for transmission over a wireless channel. The AP 102 may receive the time-domain signal and reconstruct the dRU 506 (such as by a fast Fourier transform). In some implementations, the AP 102 may include a distributed tone demapper that demaps the dRU 506 to the logical RU 504. In other words, the distributed tone demapper reverses the mapping performed by the distributed tone mapper at the STA 104. The AP 102 can recover the information carried (or modulated) on the logical RU 504 as a result of the demapping.

In the example of FIG. 5, the logical RU 504 is distributed evenly across the spreading bandwidth. While the example shown in FIG. 5 illustrates a spreading bandwidth of 40 MHz, spreading bandwidths also may include 80 MHz, 160 MHz, or 320 MHz. In some implementations, the logical RU 504 can be mapped to any suitable pattern of noncontiguous subcarrier indices. For example, in various implementations, the distance between any pair of adjacent modulated tones may be less than or greater than the distances depicted in FIG. 5.

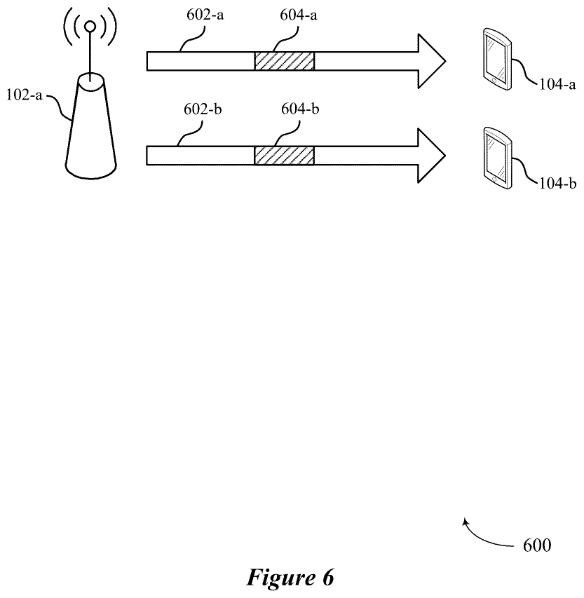

FIG. 6 shows an example of a signaling diagram 600 that supports beacon extension design. In some implementations, the signaling diagram 600 may implement or be implemented by aspects of the wireless communications network 100. For example, the signaling diagram 600 may include one or more STAs 104 (such as a STA 104-a and a STA 104-b) and one or more APs 102 (such as an AP 102-a), which may be examples of the corresponding wireless devices as described herein. The STA 104-a and the STA 104-b may each be an example of a user equipment (such as a smart phone, laptop, or similar devices). The STA 104-a and the STA 104-b may each communicate with the AP 102-a via one or more wireless links 602 (such as wireless links 602-a and 602-b). For example, the STA 104-a may receive, via the wireless link 602-a, signaling 604-a from the AP 102-a, and the STA 104-b may receive, via the wireless link 602-b, signaling 604-b from the AP 102-a. In the following description of the signaling diagram 600, the signaling 604-a may include similar information to the signaling 604-b. For example, if the signaling 604-a is described to include a first set of information, the signaling 604-b may include a second set of information that is similar to the first set of information.

The signaling 604-a and the signaling 604-b each may include one or more beacon containers. For example, the signaling 604-a may include a beacon frame, a beacon extension frame, or any combination thereof. It is noted that the signaling 604-a and the signaling 604-b may be performed between one or more STAs 104 (such as non-AP STAs). For example, the STA 104-a may transmit one or more message containers (such as a beacon frame, a beacon extension frame, or other frame or container) to the STA 104-b. Thus, although the message containers as described herein may be described as being transmitted by an AP 102 and received by a STA 104, one or more STAs 104 may transmit, receive, or both, the message containers.

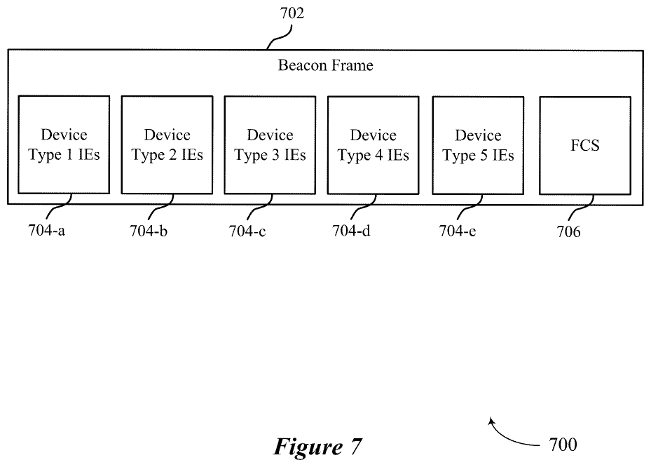

FIG. 7 shows an example of a beacon frame diagram 700 that supports beacon extension design. In some implementations, the beacon frame diagram 700 may implement or be implemented by aspects of the wireless communications network 100, the signaling diagram 600, or both. For example, the beacon frame diagram 700 includes a beacon frame 702, which may be transmitted by an AP 102 and received by a STA 104. The beacon frame 702 may include one or more sets of segments, depicted as IEs 704 (such as device type IEs 704-a, 704-b, 704-c, 704-d, 704-e, and so on). A segment may be referred to as common segment that includes one or more parameters that are common to multiple different device types (such as device type IEs 704-a). A segment also may be referred to as a type-specific segment that includes one or more parameters that are correspond to a particular device type, and also may be used by later generation device types. In some implementations, the beacon frame 702 may support beacon protection. For example, the beacon frame 702 may include fields that include information for performing error detection and message integrity procedures. To support such procedures, for example, the beacon frame 702 may include an FCS 706, a MIC, or both. In some implementations, the beacon frame 702 may include the device type IEs 704, ordered by device type. For example, device type 1 IEs 704-a may correspond with an older generation of devices compared with device type 2 IEs 704-b, device type 2 IEs 704-b may correspond with an older generation of devices compared with device type 3 IEs 704-c, and so on.

In some implementations, a STA 104 may receive the beacon frame 702 and subsequently parse one or more device type IEs 704. For example, if the STA 104 is associated with or has a device type 3, the STA 104 may parse the device type 3 IEs 704-c. In some implementations, the STA 104 may parse the device type 1 IEs 704-a and the device type 2 IEs 704-b, which may correspond with device generations older than the device generation of the STA 104. The STA 104 also may perform beacon protection procedures such as error detection and message integrity checks. For example, the STA 104 may use the FCS 706, the MIC, or both, to validate the beacon frame 702 and for detecting errors in the information segments (such as the device type IEs 704).

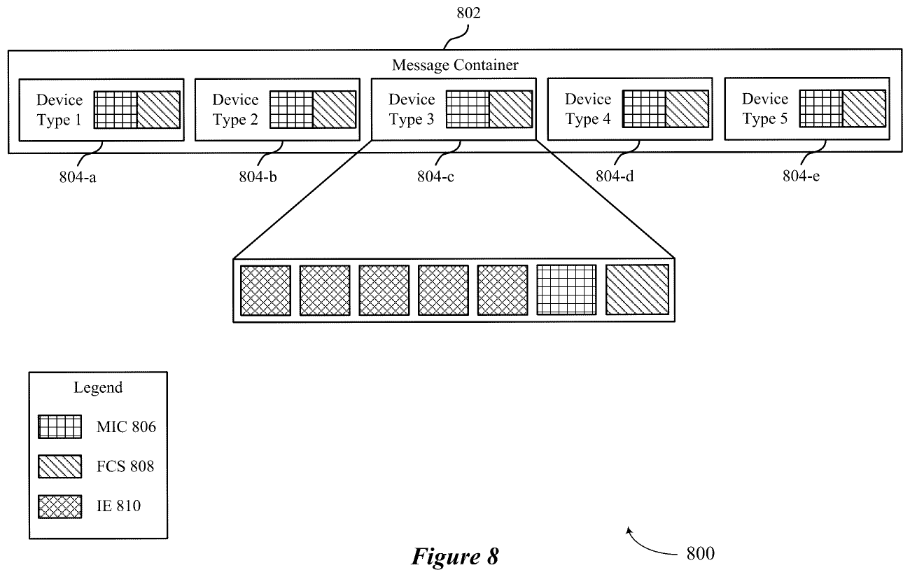

FIG. 8 shows an example of a message container diagram 800 that supports beacon extension design. In some implementations, the message container diagram 800 may implement or be implemented by aspects of the wireless communications network 100, the signaling diagram 600, or both. For example, the message container diagram 800 includes a message container 802 (or a beacon container), which may be transmitted by an AP 102 and received by a STA 104. The message container 802 may include one or more segments 804 (such as segments 804-a, 804-b, 804-c, 804-d, 804-e). A beginning segment may be referred to as a common segment that includes one or more common parameters that may be used by multiple different device generations (such as a pre-UHR segment with one or more common parameters). As discussed herein, a common parameter may refer to a parameter that is shared, or usable, by multiple different device types, device, generations and/or different versions of IEEE 802.11 (such as 802.11be, 802.11ax, etc.), or the like.

Each segment 804 of the one or more segments 804 may include a respective MIC 806, a FCS 808, one or more IEs 810 (such as a field with one or more parameters), or any combination thereof. The segments after the common segment 804-a may each be a different type-specific type (such as type-specific segments) that includes one or more parameters for a respective device type (such as UHR, UHR+, UHR++, UHR+++, etc.). Each type-specific segment may include one or more type-specific parameters (such as IEs) that correspond to a particular device type (such as particular generation), and may be used by later generation devices).

In some implementations, the message container 802 may refer to a beacon extension container, a PPDU or a similar message container. In some implementations, the message container 802 may be a beacon extension frame that includes the one or more segments 804 (such as segments 804-a, 804-b, 804-c, 804-d, 804-e). In some implementations, the message container 802 may be a PPDU, and the segments 804 of the PPDU may be a set of individual beacon extension containers (such as a set of beacon extension frames). Thus, the PPDU may carry multiple individual beacon extension containers, each including information or parameters corresponding with a device type or generation.

In some implementations, the message container may include strict ordering of segments 804. For example, the segments 804 may be ordered according to device type (such as from older to newer generation of devices). In some implementations, the device type 1 segment 804-a may correspond with an older generation of devices compared with the device type 2 segment 804-b, the device type 2 segment 804-b may correspond with an older generation of devices compared with the device type 3 segment 804-c, and so on. In some implementations, a STA 104 may have a device type (such as the device type 3, corresponding with a UHR generation) may validate the one or more IEs 810 in at least a subset of segments 804 of the one or more segments 804 using the respective MIC 806, FCS 808, or both. For example, the STA 104 may parse the device type 3 segment 804-c (including the IEs 810) and validate the IEs 810 using the MIC 806, the FCS 808, or both, and may similarly parse and validate the segments 804-a and 804-b. Thus, the STA 104 may parse the segment 804 that corresponds with its generation or device type and may additionally or alternatively parse segments 804 that correspond with previous generations or device types. For example, the STA 104 may parse the segments 804 (such as fields or IEs) up to its generation (such as up to segment 804-c), may validate the FCS associated with each segment 804 (such as validate the FCS in segment 804-a, the FCS in segment 804-b, and the FCS in segment 804-c) or corresponding to its generation (such as only validate the FCS in segment 804-c but skip validating the FCS in segment 804-b and the FCS in segment 804-a), or both, and may refrain from parsing or processing the remaining segments 804. That is, the STA 104 may skip the remaining segments 804.

In some implementations, a MIC 806, an FCS 808, or both, may be incremental across different segments 804. For example, each MIC 806 and FCS 808 may not be self-contained, but rather a given MIC 806 and a given FCS 808 may apply across one or more previous segments. Thus, while parsing multiple segments 804, a receiver (such as a STA 104) may skip the MIC 806 and the FCS 808 until the segment 804 corresponding to a device type (or generation) of the receiver. For example, the MIC 806 and the FCS 808 in the device type 3 segment 804-c may correspond with each set of IEs 810 in the segments 804-a, 804-b, and 804-c. In some implementations, the STA 104 may parse the IEs 810 in the segments 804-a, 804-b, and 804-c, and may perform error detection and message validation using the MIC 806 and the FCS 808 in the segment 804-c. For example, the STA 104 may perform a single set of error detection and message validation procedures for multiple segments in the message container 802.

In some implementations, the AP 102 may transmit one or more message containers 802, including a first message container and a second message container. The first message container may be a beacon container or a beacon extension container. Similarly, the second message container may be a beacon container or a beacon extension container. A given message container 802 may include one or more segments 804 of a group of segments 804 relevant to multiple STAs 104 of a wireless communications network. For example, the first message container may include a first portion of IEs 810 or segments 804 of the group of segments 804. The second message container may include a second portion of IEs 810 or segments 804 the group of segments 804.

In some implementations, the AP 102 may not include all segments (such as fields/IEs) in every beacon frame, beacon extension frame, or both, that the AP transmits). In an example, the AP 102 may only include segments (such as fields/IEs) whose value has changed. In an example, the second message container 802 may include IEs 810 or segments 804 whose value has changed since the AP 102 transmitted the first message container 802. In some implementations, the first message container 802 and the second message container 802 may up to always both include certain segments or certain network IEs 810, such as a TSF, a traffic indicator, or similar information. For example, the AP 102 may include the network IEs 810 in each message container 802 that the AP 102 transmits.

In some implementations, a critical updates mechanism in the message container 802 may indicate a change to one or more operational parameters at a wireless device (such as a STA 104 or an AP 102). A change count field in the critical updates mechanism may indicate a most recent (such as a latest or most recent) parameter set and also may indicate other flags (such as a critical updates framework (CUF) flag or an all updates included (AUI) flag). Similarly, the change count field may indicate a presence of updated parameters. The wireless device (such as the STA 104 or the AP 102) may include one or more critical update mechanisms or frameworks corresponding to one or more device types (or generations of devices). Alternatively, or additionally, the message container 802 may include a common critical update framework with a flag within each segment 804 indicating if there was a change to one or more parameters of the device type or generation corresponding with the respective segment 804. In some implementations, during an update (such as a critical update), a separate message container 802 (such as a beacon frame) may include fields or IEs corresponding to the update.

The STA 104 may perform active scanning (or probing) to discover IEs 810 (such as attributes) associated with a BSS of the AP 102. For example, in some implementations, the STA 104 may perform the active scanning rather than passing scanning (such as if passive scanning is insufficient for obtaining relevant attributes from the AP 102). In some implementations, the AP 102 may transmit a message container 802 as part of (or during) a delivery traffic indication message (DTIM). The message container 802 (such as a beacon extension frame or a PPDU) may carry up to a complete profile associated with the AP 102, the STA 104, or both. In some implementations, a first Delivery Traffic Indication Message (DTIM) interval associated with a first device type may be different from a second DTIM interval associated with a second device type such that the AP 102 transmits DTIMs for different device types at different instances (for example, so that not all information is carried at the same time). Thus, the AP 102 may control or limit the size of the message container 802.

It is noted that a hybrid approach may be applied, where different device types (such as generations) may have different periodicities for inclusion of respective device-type specific attributes in a beacon frame, a beacon extension frame, or both, and a beacon frame carries one or more segments (such as fields/IEs) corresponding to a critical update.

Each segment 804 may include a MIC 806 such that the STA 104 may perform an integrity check on each segment 804. For example, the respective integrity checks may be “self-contained” within each segment 804. In some implementations, the MIC 806 in each segment 804 may include one or more security parameters which are common to one or more device types. In such implementations, the security parameters for each segment 804 may be a same set of security parameters. In some implementations, if the security parameters for each segment are the same set of security parameters, a common segment 804 may include the security parameters (such as a key identifier, a packet number, or both). Alternatively, or additionally, up to each device type may correspond to a distinct set of security parameters (such as a distinct key identifier, a distinct packet number, or both, per device type). For example, if a device type has a relatively strong security algorithm, the MIC 806 for the segments corresponding to the device type may include a particular set of security parameters which is different from another set of security parameters corresponding to other device types. In some implementations, the STA 104 may verify the integrity of the data based on a packet number and a key identifier in each segment 804.

In some implementations, the information included in the segments 804 may be integrity protect (such as via a MIC 806 as described herein). In some implementations, the contents included in the segments 804 may be encrypted. In such implementations, a first set of segments 804 may have one or more common security parameters while a second set of segments 804 may have one or more type-specific security parameters based on a device type corresponding to the segments 804. In some implementations, the one or more type-specific security parameters may be relatively advanced (such as having stronger or more complex encryption) as compared to the common security parameters. For example, the common security parameters may have a relatively low denomination.

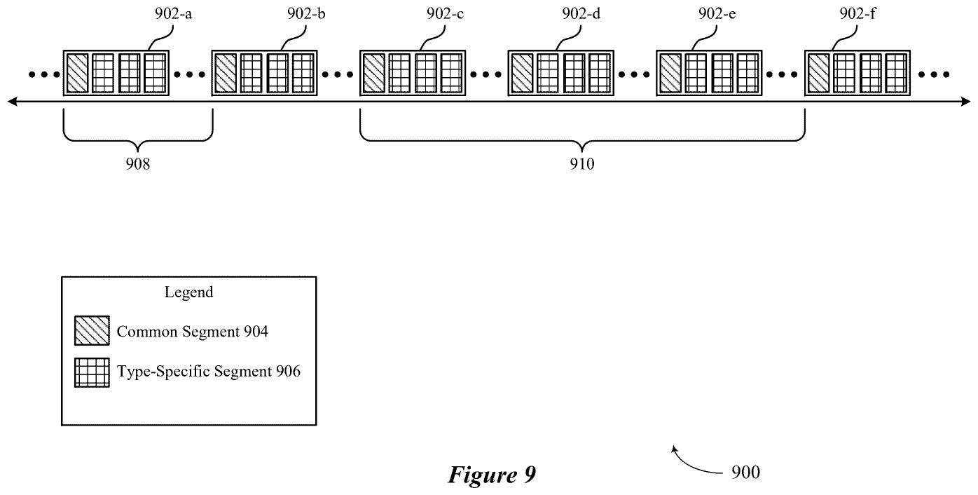

FIG. 9 shows an example of a signal timing diagram 900 that supports beacon extension design. In some implementations, the signal timing diagram 900 may implement or be implemented by aspects of the wireless communications network 100, the signaling diagram 600, the message container diagram 800, or any combination thereof. For example, the signal timing diagram 900 includes one or more message containers 902 (such as message containers 902-a, 902-b, 902-c, 902-d, 902-e, 902-f and so on), which may be respective examples of the message container 802 described with reference to FIG. 8. An AP 102 may transmit the one or more message containers 902 such that at least one STA 104 may receive each of the message containers 902. Each message container 902 may include one or more common segments 904, one or more type-specific segments 906, or any combination thereof. In some implementations, techniques described with reference to FIG. 9 may be combined with other techniques described herein.

In some implementations, different device types may be associated with different periodicities such that the AP 102 may transmit type-specific IEs or attributes (such as IEs or attributes relevant for a particular type or generation of devices) in at least a portion of a set of transmitted message containers 902. For example, a first device type (or generation of devices) may be associated with a first periodicity 908. The AP 102 may transmit the message container 902-a and after the first periodicity 908 (such as after a first duration of time) may transmit the message container 902-b. The message container 902-a and the message container 902-b may each contain a common segment 904 and one or more type-specific segments 906 (such as IEs specific to a device type or generation of devices). The type-specific segments 906 (including type-specific IEs) in the message container 902-a and the message container 902-b may correspond to the first device type, and thus a first STA 104 with the first device type may periodically receive the IEs (including parameters) corresponding to the first device type in accordance with the first periodicity.

In some implementations, some message containers (such as message containers 902-a and 902-b) may include a common segment 904 and zero or more type-specific segments 906. In such implementations, the periodicity 908 may be associated with transmitting information common to STAs 104 in a BSS of the AP 102. For example, the AP 102 may transmit, in each message container 902, network information (such as fields or IEs) including a TSF, traffic indicator, or similar information. In some implementations, a periodicity corresponding to a beacon frame may be greater than the first periodicity 908, such that one or more STAs 104 in the BSS may receive the network information with greater frequency than the one or more STAs 104 receive the beacon frame. For example, the first periodicity may be defined as a relatively short interval or may have a same value as another interval (such as dot11FILSFDFrameBeaconMaximumInterval, or 100 milliseconds).

In some implementations, a second device type may be associated with a second periodicity 910. For example, the AP 102 may transmit the message container 902-c and after the second periodicity 910 (such as after a second duration of time) may transmit the message container 902-f. The message container 902-c and the message container 902-f may each contain common segments 904 and type-specific segments 906. The type-specific segments 906 (including type-specific IEs) in the message container 902-c and the message container 902-f may correspond to the second device type. Thus, a second STA 104 with the second device type may periodically receive the IEs, including operational and capability IEs, corresponding to the second device type in accordance with the second periodicity 910. For example, operational and capabilities IEs may be present once every n beacons, where n may have a distinct value or a same value for individual device types. In addition, a periodicity of legacy beacon may be increased (from 100 ms to say 500 ms) and every 100 ms or so, a shorter beacon-like frame (such as Fast Initial Link Setup (FILS) Discovery) may be sent carrying selected segments (such as essential fields/IEs). A shorter beacon interval may be specified or a MIB, such as dot11FILSFDFrameBeaconMaximumInterval, may be set to 100 ms.

It is noted that a hybrid approach may be applied, where the AP 102 AP may not include all segment (such as fields/IEs) in every beacon frame, beacon extension frame, or both, that the AP 102 transmits, and different device types (such as generations) may have different periodicities for inclusion of respective device-type specific attributes in a beacon frame, a beacon extension frame, or both.

In some implementations, a particular common segment 904 may include information (such as fields or IEs) that are applicable to more than one device type (such as applicable to multiple or all generations of devices). The particular common segment 904 may include an FCS and a presence bitmap. The presence bitmap may indicate which fields or IEs are present in the particular common segment 904. The presence bitmap may indicate capability information of the AP 102 such as features which the AP 102 may support. Additionally, or alternatively, the particular common segment 904 may include a mechanism to identify the order of segments in a given message container 902. For example, the particular common segment 904 may include a field that identifies the presence and order of segments with respect to device type (or generation). In some implementations, each common segment 904 and each type-specific segment 906 may include a respective field (such as at the beginning of the segment) that identifies the device type corresponding to the respective segment.

In some implementations, a segment (such as a common segment 904 or a type-specific segment 906) may include an indication of which fields or IEs are present in the segment. For example, the segment may include a bitmap that identifies each IE or field or a category of IEs or fields. In some implementations, the bitmap may include a bit flag indicating a complete or a partial profile. For example, a ‘0’ may indicate that the segment includes a partial profile corresponding to a device type, while a ‘1’ may indicate that the segment includes a complete profile corresponding to the device type.

In some implementations, a particular message container 902 (such as any message container 902, a beacon frame, a probe response frame) may include an indication that indicates which device type (or generation) is included in the respective segments of the particular message container 902. The particular message container 902 may include a bitmap with a bit corresponding to each supported device type. For example, a ‘0’ may indicate that the particular message container 902 does not include information relevant to a particular device type, while a ‘1’ may indicate that the particular message container 902 includes information for the particular device type. In some implementations, one or more bits in the bitmap may indicate which device types (or generations) are supported by the AP 102. For example, a ‘0’ may indicate that a particular device type is not supported by the AP 102 while a ‘1’ may indicate that the particular device type is supported by the AP 102.

In some implementations, the message container 902-a may be an example of a beacon frame. The beacon frame may include an indication of whether the AP 102 may transmit a beacon extension frame (or a message extension container). For example, the beacon frame may indicate whether all the information is included in the beacon frame and may similarly indicate whether some portion is carried in a beacon extension frame. The beacon frame also may include an indication which indicates that IEs or segments corresponding to a device type are carried within the beacon frame or that the IEs or segments corresponding to the device type are carried within the beacon extension frame.

In some implementations, a segment (such as a common segment 904 or a type-specific segment 906) may include a length field. The length field may indicate the length of the segment. For example, the length field may indicate a number of bytes that the segment occupies. A STA 104 may identify the value in the length field prior to parsing each segment in a message container 902. The STA 104 also may determine the generation corresponding to each segment. If the STA 104 determines that a given segment is not relevant to a device type of the STA 104, the STA 104 may skip the given segment by skipping the quantity of bytes in the length field corresponding to that segment.

The framework discussed herein may provide flexibility for an AP to advertise one or more self-contained type-specific parameters or to advertise parameters in an incremental manner, such as where each new device-type (such as new generation) builds on top of one or more previous generations (such as only one or more new parameters defined by that generation are included in the generation segment).

In some implementations, the AP 102 may support processes relating to multiple BSS identifiers (MBSSIDs). For example, the AP 102 may transmit a BSSID, and the transmitted BSSID may correspond to a transmitted beacon extension frame that carries one or more MBSSID IEs. In some implementations, the transmitted beacon extension frame may include an MBSSID extension IE corresponding to the beacon extension frame. Thus, the beacon extension frame may include information identifying non-transmitted BSSIDs. In some implementations, MBSSID inheritance may be based on any of the following: the message container 902-a (or a beacon frame) and the message container 902-b (or a follow-up beacon extension frame), content or information within each message container 902 independently, or any combination thereof. For example, the MBSSID of a BSS may be inherited based on one or more message containers 902. Additionally, or alternatively, the MBSSID may be inherited based on IEs within a message container 902.

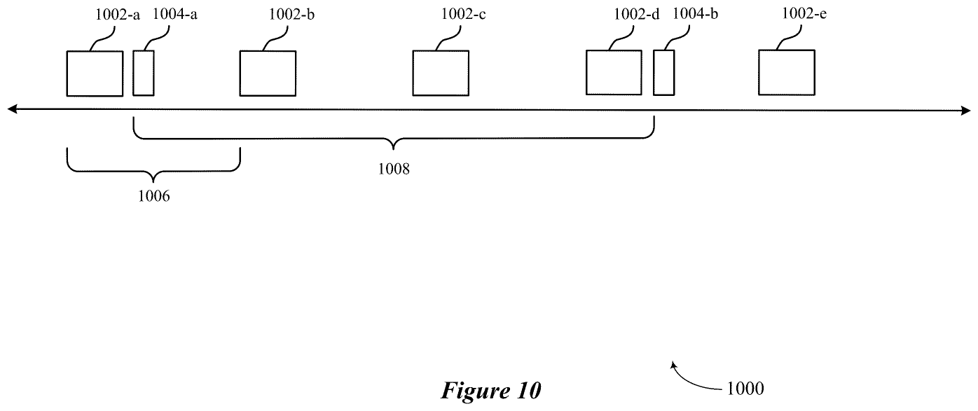

FIG. 10 shows an example of a signal timing diagram 1000 that supports beacon extension design. In some implementations, the signal timing diagram 1000 may implement or be implemented by aspects of the wireless communications network 100, the signaling diagram 600, the message container diagram 800, the signal timing diagram 900, or any combination thereof. For example, the signal timing diagram 1000 includes one or more first message containers 1002 (such as first message containers 1002-a, 1002-b, 1002-c, 1002-d, 1002-e, and so on) and one or more second message containers 1004 (such as second message containers 1004-a, 1004-b, and so on), which may be respective examples of the message container 802 described with reference to FIG. 8. An AP 102 may transmit the one or more message containers 1002 and 1004 such that at least one STA 104 may receive each of the message containers 1002 and 1004.

In some implementations, the first message containers 1002 may be respective examples of beacon frames. The first message containers 1002 may include network information such as a TSF, traffic indicator, or similar information (such as a segment that includes essential fields/IEs). Additionally, or alternatively, the first message containers 1002 may include update information (such as critical updates to parameters relevant to STAs 104 of a particular type or a common type), one or more fields having that data change that frequently changes (such as between beacon frames, beacon extension frames, or both), or similar information associated with a device type of a receiving STA 104. The first message containers 1002 may be associated with a first periodicity 1006. For example, the AP 102 may transmit the first message container 1002-a, and after a first duration of time (such as corresponding to the first periodicity 1006), the AP 102 may transmit the first message container 1002-b.

In some implementations, the second message containers 1004 may be respective examples of beacon extension frames. The second message containers 1004 may include other information such as type-specific IEs, parameter updates, or similar information. In some implementations, the AP 102 may transmit the second message containers 1004 during a DTIM beacon transmission. Each device type may correspond with a respective DTIM interval such that the AP 102 transmits DTIMs for different device types at different instances (for example, so that not all information is carried at the same time). Thus, the AP 102 may control or limit the size of the second message containers 1004. The second message containers 1004 may be associated with a second periodicity 1008. For example, the AP 102 may transmit the second message container 1004-a, and after a second duration of time (such as corresponding to the second periodicity 1008), the AP 102 may transmit the second message container 1004-b. The second periodicity 1008 may have a value greater than the value of the first periodicity 1006.

It is noted that a hybrid approach may be applied, where different device types (such as generations) may have different periodicities for inclusion of respective device-type specific attributes in a beacon frame, a beacon extension frame, or both, and a beacon frame carries one or more segments (such as essential fields/IEs) and a critical update, while the beacon extension frame carries one or more other segments (such as other fields/IEs).

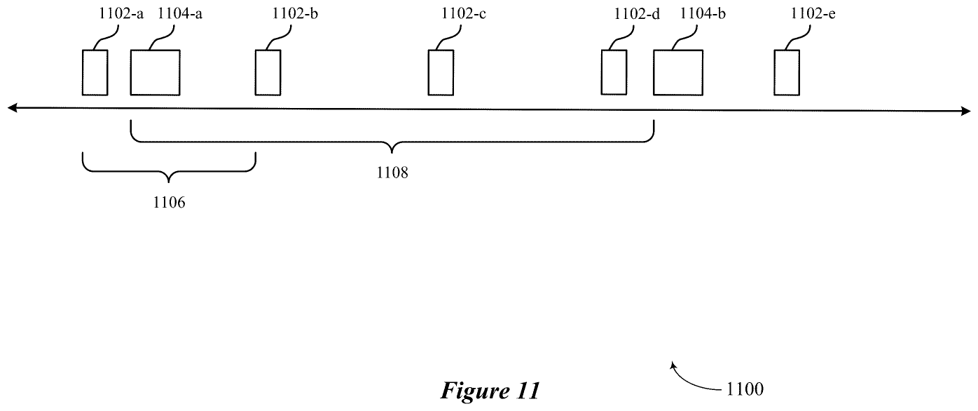

FIG. 11 shows an example of a signal timing diagram 1100 that supports beacon extension design. In some implementations, the signal timing diagram 1100 may implement or be implemented by aspects of the wireless communications network 100, the signaling diagram 600, the message container diagram 800, the signal timing diagram 900, or any combination thereof. For example, the signal timing diagram 1100 includes one or more first message containers 1102 (such as first message containers 1102-a, 1102-b, 1102-c, 1102-d, 1102-e, and so on) and one or more second message containers 1104 (such as second message containers 1104-a, 1104-b, and so on), which may be respective examples of the message container 802 described with reference to FIG. 8. An AP 102 may transmit the one or more message containers 1102 and 1104 such that at least one STA 104 may receive each of the message containers 1102 and 1104.

In some implementations, such as for green-field deployment, the AP 102 may transmit the first message containers 1102 (which may be beacon extension frames or PPDUs) in accordance with a first periodicity 1106. The first message containers 1102 may be shorter than (or may occupy less data or memory than) the second message containers 1104. The first message containers 1102 may include network information such as a TSF, traffic indicators, fast initial link setup information, and so on (such as essential fields/IEs). Additionally, or alternatively, the first message containers 1102 may each include update information (such as critical updates to signaling parameters).

The AP 102 may similarly transmit the second message containers 1104 (which may be beacon frames) in accordance with a second periodicity 1108. The second message containers may include a complete profile (including signaling parameters) for a device type. In some implementations, the second message containers may include semi-static fields. The second periodicity 1108 may correspond to a longer duration than the first periodicity 1106.

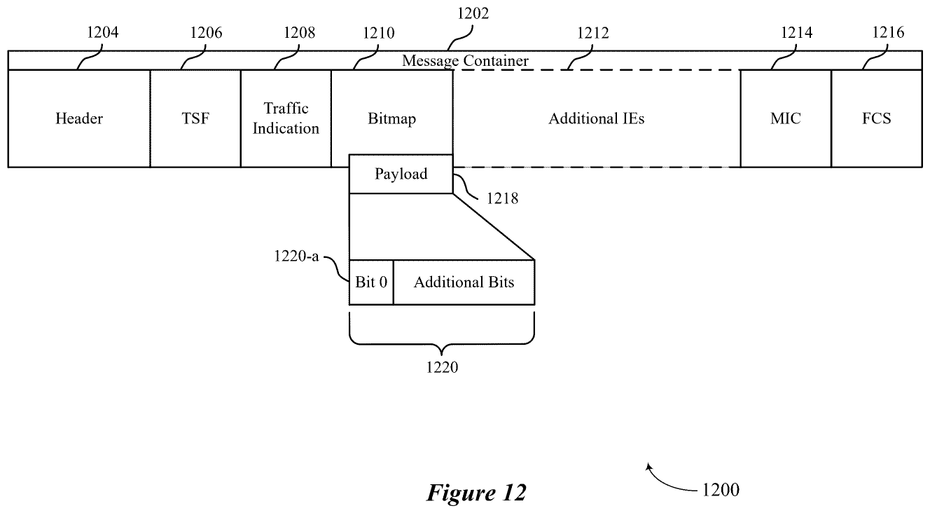

FIG. 12 shows an example of a message container diagram 1200 that supports beacon extension design. In some implementations, the message container diagram 1200 may implement or be implemented by aspects of the wireless communications network 100, the signaling diagram 600, the message container diagram 800, or any combination thereof. For example, the message container diagram 1200 includes a message container 1202 (or a beacon container), which may be transmitted by an AP 102 and received by a STA 104. The message container 1202 may include a one or more segments or fields. Each segment or field may include a respective set of information. In some implementations, the message container 1202 may be referred to as a mini-beacon (such as a type-specific or generation-specific mini-beacon).

In some implementations, the STA 104 may receive, from the AP 102, the message container 1202 that includes fields including a set of information. The message container 1202 may be a beacon frame, a beacon extension frame, or a type-specific mini-beacon. For example, the fields may include a header field 1204 (such as an MPDU header). In some implementations, the set of information may include a TSF 1206 with a relatively high granularity (such as below microseconds of granularity). The set of information may include a traffic indication 1208 (such as a TIM) that supports compression, aid assignment, or similar processes.

In some implementations, the set of information may include a bitmap 1210 that indicates one or more device types (or generations) that the AP 102 supports. The bitmap 1210 may include a payload 1218 (such as an IE payload) including a set of bits 1220. Each bit of the set of bits may correspond to a device type (such as a generation of devices) of a set of device types. For example, if the message container 1202 includes information relevant to a first device type, a bit 1220-a corresponding to the first device type may have a value of ‘1’. If the message container 1202 does not include information relevant to a second device type, a bit 1220 corresponding to the second device type may have a value of ‘0’.

In some implementations, the set of information may include a set of additional IEs 1212, including a set of IEs or fields. For example, the set of IEs or fields may include IEs that were recently updated (such as IEs that were updated since a last transmission). The AP 102 may include the set of IEs or fields for a quantity of beacon intervals (such as 10 beacon intervals or until the next xth DTIM, where x is an ordinal number of DTIM). For example, the AP 102 may include the set of IEs or fields for a particular device type for a quantity of consecutive beacons. In some implementations, the AP 102 may limit the quantity of consecutive beacons that may include the set of IEs or fields for the particular device type. In some implementations, the set of information may include a MIC 1214 and an FCS 1216. The MIC 1214 and the FCS 1216 each may correspond to the contents of the entire frame (such as the MIC 1214 and the FCS 1216 each may be computed, at a wireless communication device, across the contents of the entire frame).

In some implementations, a STA 104 may determine capabilities and operational parameters of an AP 102 based on the message container 1202. The STA 104 may perform a probing procedure. For example, the STA 104 may include a request element, for example, as part of the probing procedure to request particular IEs from the AP 102 (such as IEs belonging to the AP 102). In some implementations, a group of STAs 104 (such as a group that is unassociated with the AP 102) may perform active scanning to gather capability parameters, operations parameters, or other attributes of the AP 102.

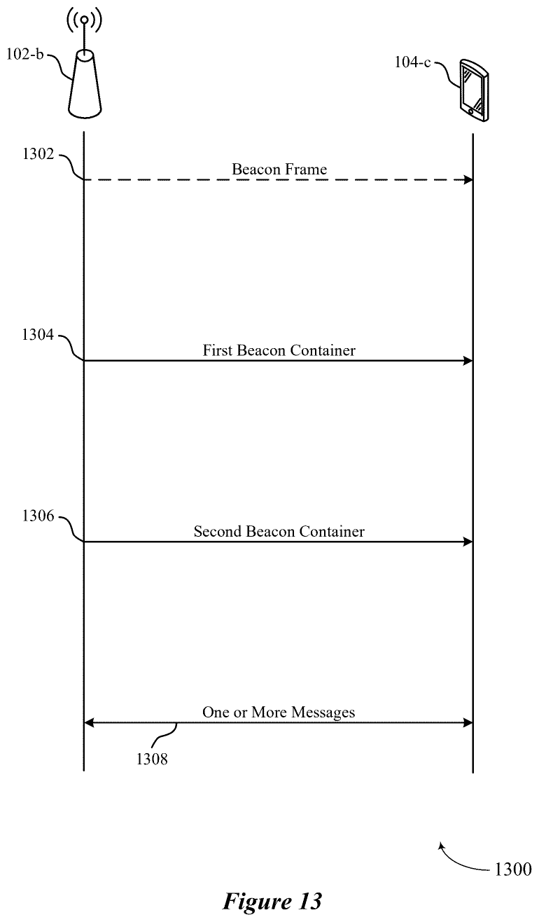

FIG. 13 shows an example of a process flow 1300 that supports beacon extension design. The process flow 1300 includes an AP 102-b and a STA 104-c, which may be examples of the corresponding devices as described with respect to FIGS. 1 and 6. In the following description of the process flow 1300, the operations between the AP 102-b and the STA 104-c may be performed in a different order than the example order shown. Some operations also may be omitted from the process flow 1300, and other operations may be added to the process flow 1300. Further, although some operations or signaling may be shown to occur at different times for discussion purposes, these operations may actually occur at the same time. Although the operations may be described to be performed between the AP 102-b and the STA 104-c, the operations may be performed between one or more STAs 104, one or more APs 102, or any combination thereof. Additionally, the techniques discussed in this figure, as well as throughout this application, may apply to an infrastructure BSS (e.g., a BSS setup by an AP) or a non-infrastructure BSS (e.g., as a P2P network such as TDLS, Wi-Fi Direct, etc.).

At 1302, the STA 104-c may receive a beacon frame from the AP 102-b. The beacon frame may be an example of the beacon frame as described with reference to FIG. 7. For example, the beacon frame may include one or more communication parameters for the STA 104-c.

At 1304, the STA 104-c may receive, from the AP 102-b, a first message container that includes a first set of one or more type-specific segments. A first type-specific segment of the first set of one or more type-specific segments may include a first set of one or more type-specific parameters. In some implementations, the first message container may include an indication (such as an indication carried in a beacon frame or probe response frame) that indicates that at least a first portion of the first set of one or more type-specific parameters is included in the first message container, that at least a second portion of the first set of one or more type-specific parameters is included in the second message container, or both. The indication is based on the device type of the STA 104-c.

In some implementations, the STA 104-c may receive, from the AP 102-b, a set of one or more first message containers in accordance with a first periodicity. In some implementations, the set of one or more first message containers may include the first message container. Each first message container of the set of one or more first message containers may include one or more common parameters.

At 1306, the STA 104-c may receive, from the AP 102-b, a second message container that includes a second set of one or more type-specific segments. In some implementations, the first message container may be an example of a beacon frame and the second message container may be an example of a beacon extension frame (such as a follow-up frame). In some implementations, the first message container may be an example of a beacon extension frame and the second message container may be an example of a beacon frame.

The first type-specific segment and a second type-specific segment of the second set of one or more type-specific segments may both correspond to a device type of the STA 104-c. In some implementations, the second type-specific segment may indicate an update to at least one parameter of the first set of one or more type-specific parameters. In some implementations, the second message container may include one or more FCSs. Each segment of the second set of one or more type-specific segments includes a respective frame check sequence of the one or more frame check sequences. In some implementations, the second message container may include one or more MICs. Each segment of the second set of one or more type-specific segments may include a respective MIC of the one or more MICs. In some implementations, at least one type-specific segment of the second set of one or more type-specific segments may include an indication of a length of the at least one type-specific segment.

The second message container may be an example of a type-specific management frame (such as a type-specific beacon, a type-specific mini-beacon) which includes at least one of a first traffic indicator, a first TSF, an indication of one or more supported device types, a type-specific parameter update, a MIC, an FCS, or any combination thereof. In some implementations, the type-specific management frame may correspond to the device type of the STA 104-c. In some implementations, the type-specific management frame may be communicated via a broadcast message or may be sent to a broadcast or group address. It is noted that one or more fields or elements included or carried in the second message container may have a different format, a different encoding, or a different interpretation than corresponding fields or elements included or carried in the first message container. For example, in some implementations, the first message container may include a second traffic indicator having a different format, a different encoding, or a different interpretation than the first traffic indicator, a second TSF having a different format, a different encoding, or a different interpretation than the first TSF, or both. It is noted that some operations (as an example, beacon protection) that do not apply to certain fields, elements, or both, in the first container (such as in the legacy beacon) may be applied and/or applicable to fields, elements, or both, carried in some or all segments in the second container, as, for example, a newer generation of a non-AP STA may support that feature and/or operation.

In some implementations, the STA 104-c may receive, from the AP 102-b, a set of one or more second message containers in accordance with a second periodicity. The second periodicity may be greater than the first periodicity based on a device type of the STA 104-c. In some implementations, the set of one or more second message containers may include the second message container. Each second message container of the set of one or more second message containers may include a second set of one or more type-specific parameters. The second set of one or more type-specific parameters may correspond to the device type of the STA 104-c. In some implementations, the one or more messages may be communicated with the access point in accordance with the one or more common parameters and the second set of one or more type-specific parameters. In some implementations, at least one message container of the one or more second message containers includes an indication of which one or more type-specific segments are included in the at least one message container.

At 1308, the STA 104-c may communicate one or more messages with the AP 102-b in accordance with the first type-specific segment and the second type-specific segment.

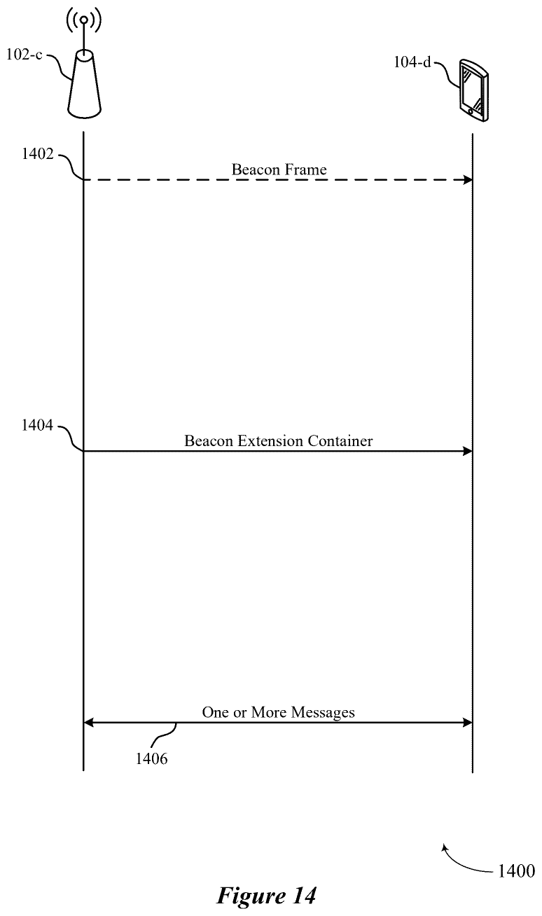

FIG. 14 shows an example of a process flow 1400 that supports beacon extension design. The process flow 1400 includes an AP 102-c and a STA 104-d, which may be examples of the corresponding devices as described with respect to FIGS. 1 and 6. In the following description of the process flow 1400, the operations between the AP 102-c and the STA 104-d may be performed in a different order than the example order shown. Some operations also may be omitted from the process flow 1400, and other operations may be added to the process flow 1400. Further, although some operations or signaling may be shown to occur at different times for discussion purposes, these operations may actually occur at the same time. Although the operations may be described to be performed between the AP 102-c and the STA 104-d, the operations may be performed between one or more STAs 104, one or more APs 102, or any combination thereof.

At 1402, the STA 104-d may receive a beacon frame from the AP 102-c. The beacon frame may be an example of the beacon frame as described with reference to FIG. 7. For example, the beacon frame may include one or more communication parameters for the STA 104-d.

At 1404, the STA 104-d may receive, from the AP 102-c a message extension container (such as a beacon extension container or a follow-up container) that comprises one or more segments. The one or more segments may include a common segment with one or more common parameters and a set of one or more type-specific segments. Each type-specific segment of the set of one or more type-specific segments may include a respective set of one or more type-specific parameters that correspond to a respective device type of multiple device types.

In some implementations, the message extension container may be an example of a PPDU that includes one or more beacon extension frames. In some implementations, the message extension container may be an example of a beacon extension frame. In some implementations, the message extension container may include one or more FCSs. Each segment of the one or more segments may include a respective FCSs of the one or more FCSs. In some implementations, the message extension container may include one or more MICs. Each segment of the one or more segments includes a respective MIC of the plurality of MICs.

At 1406, the STA 104-d may communicate one or more messages with the AP 102-c in accordance with the one or more common parameters and a first set of one or more type-specific parameters from a first type-specific segment. The first type specific segment may be from the one or more segments that corresponds to a device type of the STA 104-d. In some implementations, the STA 104-d may communicate the one or more messages with the AP 102-c in accordance with a second set of one or more type-specific parameters from one or more second type-specific segments from the one or more segments. The one or more second type-specific segments may be based on the device type of the first wireless device.

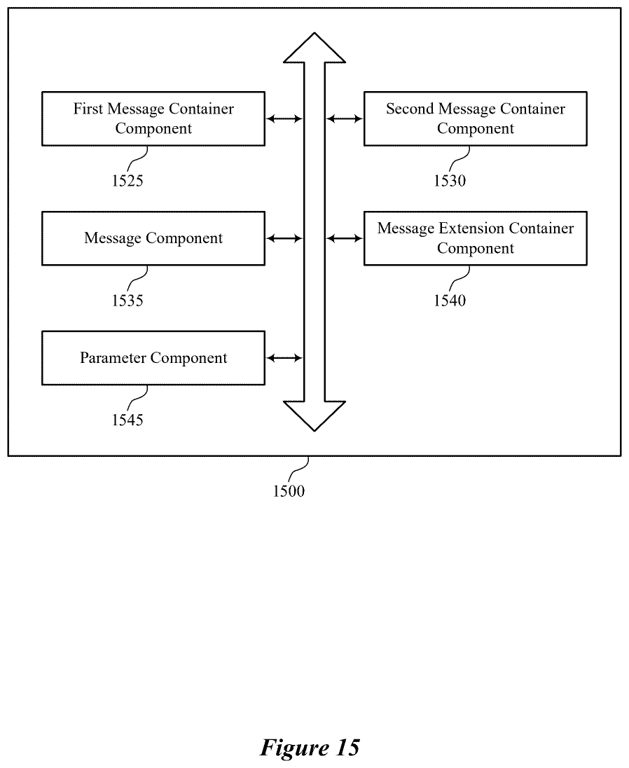

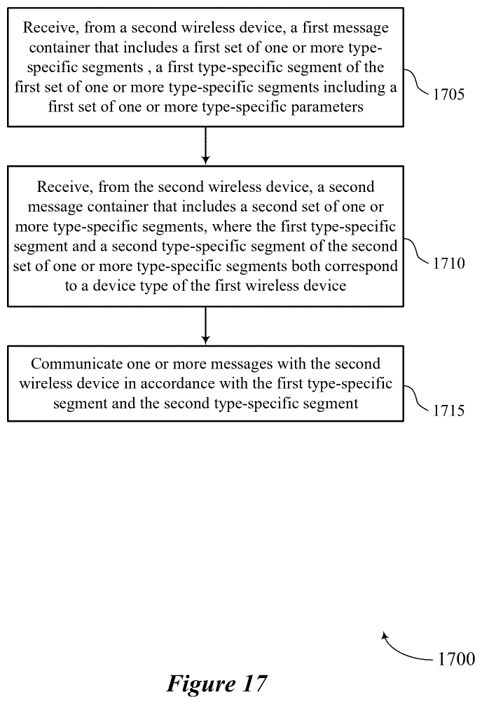

FIG. 15 shows a block diagram of an example wireless communication device 1500 that supports beacon extension design. In some implementations, the wireless communication device 1500 is configured to perform the processes 1700, 1800, and 2000 described with reference to FIGS. 17, 18, and 20, respectively. The wireless communication device 1500 may include one or more chips, SoCs, chipsets, packages, components or devices that individually or collectively constitute or include a processing system. The processing system may interface with other components of the wireless communication device 1500, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1500 may transmit the information output from the chip. In such an example, the second interface may refer to an interface between the processing system of the chip and a reception component, such that the wireless communication device 1500 may receive information that is then passed to the processing system. In some such examples, the first interface also may obtain information, such as from the transmission component, and the second interface also may output information, such as to the reception component.

The processing system of the wireless communication device 1500 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the wireless communication device 1500 can be configurable or configured for use in a STA, such as the STA 104 described with reference to FIG. 1. In some other examples, the wireless communication device 1500 can be a STA that includes such a processing system and other components including multiple antennas. The wireless communication device 1500 is capable of transmitting and receiving wireless communications in the form of, for example, wireless packets. For example, the wireless communication device 1500 can be configurable or configured to transmit and receive packets in the form of physical layer PPDUs and MPDUs conforming to one or more of the IEEE 802.11 family of wireless communication protocol standards. In some other examples, the wireless communication device 1500 can be configurable or configured to transmit and receive signals and communications conforming to one or more 3GPP specifications including those for 5G NR or 6G. In some implementations, the wireless communication device 1500 also includes or can be coupled with one or more application processors which may be further coupled with one or more other memories. In some implementations, the wireless communication device 1500 further includes a user interface (UI) (such as a touchscreen or keypad) and a display, which may be integrated with the UI to form a touchscreen display that is coupled with the processing system. In some implementations, the wireless communication device 1500 may further include one or more sensors such as, for example, one or more inertial sensors, accelerometers, temperature sensors, pressure sensors, or altitude sensors, that are coupled with the processing system.

The wireless communication device 1500 includes a first message container component 1525, a second message container component 1530, a message component 1535, a message extension container component 1540, and a parameter component 1545. Portions of one or more of the first message container component 1525, the second message container component 1530, the message component 1535, the message extension container component 1540, and the parameter component 1545 may be implemented at least in part in hardware or firmware. For example, one or more of the first message container component 1525, the second message container component 1530, the message component 1535, the message extension container component 1540, and the parameter component 1545 may be implemented at least in part by at least a processor or a modem. In some implementations, portions of one or more of the first message container component 1525, the second message container component 1530, the message component 1535, the message extension container component 1540, and the parameter component 1545 may be implemented at least in part by a processor and software in the form of processor-executable code stored in memory.

The wireless communication device 1500 may support wireless communications in accordance with examples as disclosed herein. The first message container component 1525 is configurable or configured to receive, from a second wireless device, a first message container that includes a first set of one or more type-specific segments, a first type-specific segment of the first set of one or more type-specific segments including a first set of one or more type-specific parameters. The second message container component 1530 is configurable or configured to receive, from the second wireless device, a second message container that includes a second set of one or more type-specific segments, where the first type-specific segment and a second type-specific segment of the second set of one or more type-specific segments both correspond to a device type of the first wireless device. The message component 1535 is configurable or configured to communicate one or more messages with the second wireless device in accordance with the first type-specific segment and the second type-specific segment.

In some implementations, the first message container and the second message container are received via a primary channel. In some implementations, a single physical layer protocol data unit (PPDU) comprises the first message container and the second message container. In some implementations, a first physical layer protocol data unit (PPDU) comprises the first message container and a second PPDU comprises the second message container. In some implementations, the first type-specific segment, the second type-specific segment, or both, comprise an information element, a field, or both. In some implementations, the first type-specific segment comprises information to configure the device type of the first wireless device and one or more generations of device types prior to the device type, and wherein the second type-specific segment comprises information to configure the device type of the first wireless device.

In some implementations, the second type-specific segment indicates an update to at least one parameter of the first set of one or more type-specific parameters.

In some implementations, to support receiving the first message container, the first message container component 1525 is configurable or configured to receive the first message container including an indication (such as an indication carried in a beacon frame or a probe response frame) that indicates that at least a first portion of the first set of one or more type-specific parameters is included in the first message container, that at least a second portion of the first set of one or more type-specific parameters is included in the second message container, or both, where the indication is based on the device type of the first wireless device.

In some implementations, the first message container component 1525 is configurable or configured to receive, in accordance with a first periodicity, a set of one or more first message containers. In some implementations, the second message container component 1530 is configurable or configured to receive, in accordance with a second periodicity, a set of one or more second message containers, where the second periodicity is greater than the first periodicity.

In some implementations, the first message container component 1525 is configurable or configured to receive, in accordance with a first periodicity, a set of one or more first message containers each including one or more common parameters. In some implementations, the second message container component 1530 is configurable or configured to receive, in accordance with a second periodicity, a set of one or more second message containers each including a second set of one or more type-specific parameters, where the second set of one or more type-specific parameters corresponds to the device type of the first wireless device.

In some implementations, the one or more messages are communicated with the second wireless device in accordance with the one or more common parameters and the second set of one or more type-specific parameters.

In some implementations, at least one message container of the set of one or more second message containers includes an indication of which one or more type-specific segments are included in the at least one message container.

In some implementations, to support receiving the second message container, the second message container component 1530 is configurable or configured to receive the second message container including a set of multiple frame check sequences, where each segment of the second set of one or more type-specific segments includes a respective frame check sequence of the set of multiple frame check sequences.

In some implementations, to support receiving the second message container, the second message container component 1530 is configurable or configured to receive the second message container including a set of multiple message integrity codes, where each segment of the second set of one or more type-specific segments includes a respective message integrity code of the set of multiple message integrity codes.

In some implementations, the second message container is a type-specific management frame which includes at least one of a first traffic indicator, a first timing synchronization function, an indication of one or more supported device types, a type-specific parameter update, a message integrity code, a frame check sequence, or any combination thereof. In some implementations, the type-specific management frame corresponds to the device type of the first wireless device.

In some implementations, the first message container includes a second traffic indicator having a different format, a different encoding, or a different interpretation than the first traffic indicator, a second timing synchronization function having a different format, a different encoding, or a different interpretation than the first timing synchronization function, or both.

In some implementations, at least one type-specific segment of the second set of one or more type-specific segments includes an indication of a length of the at least one type-specific segment.

In some implementations, the first message container is a beacon frame and the second message container is a beacon extension frame.

In some implementations, the first message container is a beacon extension frame and the second message container is a beacon frame.

Additionally, or alternatively, the wireless communication device 1500 may support wireless communications in accordance with examples as disclosed herein. The message extension container component 1540 is configurable or configured to receive, from a second wireless device, a message extension container that includes one or more segments, the one or more segments including a common segment with one or more common parameters and a set of one or more type-specific segments, each type-specific segment of the set of one or more type-specific segments including a respective set of one or more type-specific parameters that correspond to a respective device type of a set of multiple device types. The parameter component 1545 is configurable or configured to communicate one or more messages with the second wireless device in accordance with the one or more common parameters and a first set of one or more type-specific parameters from a first type-specific segment from the one or more segments that corresponds to a device type of the first wireless device.

In some implementations, to support communicating the one or more messages, the parameter component 1545 is configurable or configured to communicate the one or more messages with the second wireless device in accordance with a second set of one or more type-specific parameters from one or more second type-specific segments from the one or more segments, the one or more second type-specific segments based on the device type of the first wireless device.

In some implementations, to support receiving the message extension container, the message extension container component 1540 is configurable or configured to receive the message extension container including a set of multiple frame check sequences, where each segment of the one or more segments includes a respective frame check sequence of the set of multiple frame check sequences.

In some implementations, to support receiving the message extension container, the message extension container component 1540 is configurable or configured to receive the message extension container including a set of multiple message integrity codes, where each segment of the one or more segments includes a respective message integrity code of the set of multiple message integrity codes.

In some implementations, the message extension container is a physical layer protocol data unit that includes a set of multiple beacon extension frames.

In some implementations, the message extension container is a beacon extension frame.

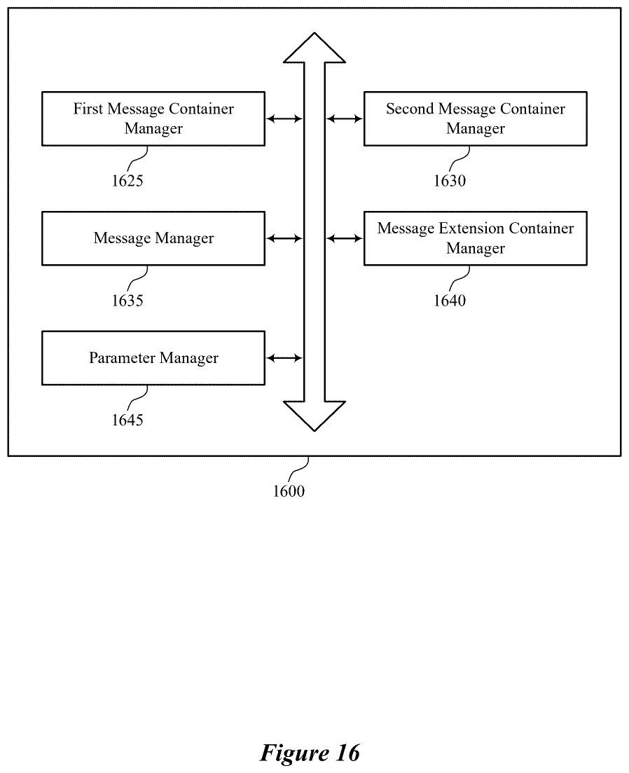

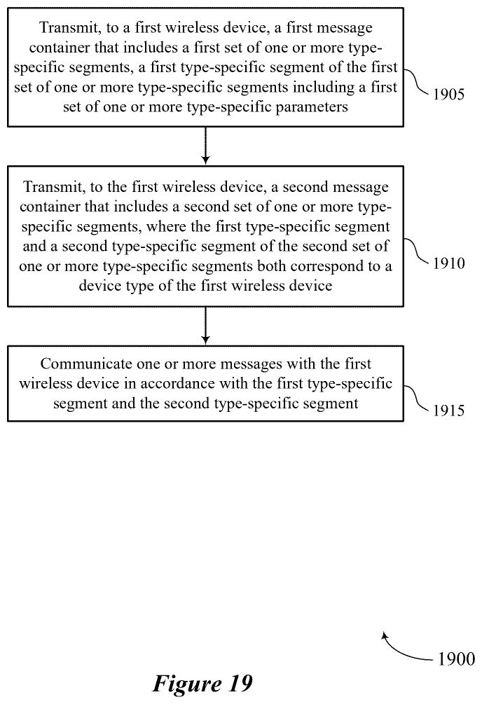

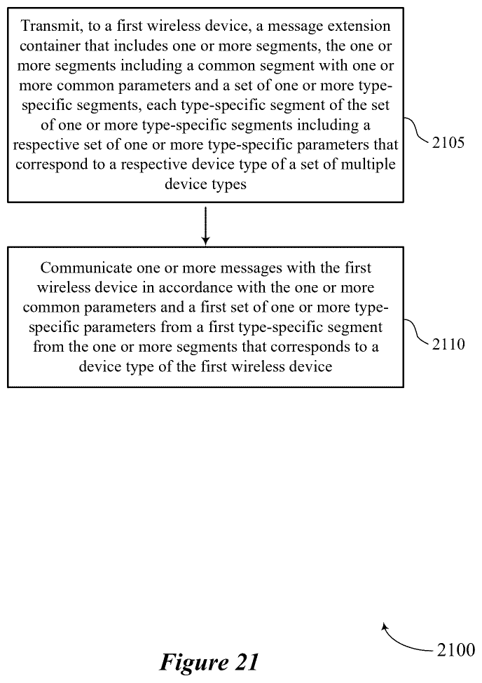

FIG. 16 shows a block diagram of an example wireless communication device 1600 that supports beacon extension design. In some implementations, the wireless communication device 1600 is configured to perform the processes 1900 and 2100 described with reference to FIGS. 19 and 21, respectively. The wireless communication device 1600 may include one or more chips, SoCs, chipsets, packages, components or devices that individually or collectively constitute or include a processing system. The processing system may interface with other components of the wireless communication device 1600, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1600 may transmit the information output from the chip. In such an example, the second interface may refer to an interface between the processing system of the chip and a reception component, such that the wireless communication device 1600 may receive information that is then passed to the processing system. In some such examples, the first interface also may obtain information, such as from the transmission component, and the second interface also may output information, such as to the reception component.

The processing system of the wireless communication device 1600 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the wireless communication device 1600 can be configurable or configured for use in an AP, such as the AP 102 described with reference to FIG. 1. In some other examples, the wireless communication device 1600 can be an AP that includes such a processing system and other components including multiple antennas. The wireless communication device 1600 is capable of transmitting and receiving wireless communications in the form of, for example, wireless packets. For example, the wireless communication device 1600 can be configurable or configured to transmit and receive packets in the form of physical layer PPDUs and MPDUs conforming to one or more of the IEEE 802.11 family of wireless communication protocol standards. In some other examples, the wireless communication device 1600 can be configurable or configured to transmit and receive signals and communications conforming to one or more 3GPP specifications including those for 5G NR or 6G. In some implementations, the wireless communication device 1600 also includes or can be coupled with one or more application processors which may be further coupled with one or more other memories. In some implementations, the wireless communication device 1600 further includes at least one external network interface coupled with the processing system that enables communication with a core network or backhaul network that enables the wireless communication device 1600 to gain access to external networks including the Internet.

The wireless communication device 1600 includes a first message container manager 1625, a second message container manager 1630, a message manager 1635, a message extension container manager 1640, and a parameter manager 1645. Portions of one or more of the first message container manager 1625, the second message container manager 1630, the message manager 1635, the message extension container manager 1640, and the parameter manager 1645 may be implemented at least in part in hardware or firmware. For example, one or more of the first message container manager 1625, the second message container manager 1630, the message manager 1635, the message extension container manager 1640, and the parameter manager 1645 may be implemented at least in part by at least a processor or a modem. In some implementations, portions of one or more of the first message container manager 1625, the second message container manager 1630, the message manager 1635, the message extension container manager 1640, and the parameter manager 1645 may be implemented at least in part by a processor and software in the form of processor-executable code stored in memory.

The wireless communication device 1600 may support wireless communications in accordance with examples as disclosed herein. The first message container manager 1625 is configurable or configured to transmit, to a first wireless device, a first message container that includes a first set of one or more type-specific segments, a first type-specific segment of the first set of one or more type-specific segments including a first set of one or more type-specific parameters. The second message container manager 1630 is configurable or configured to transmit, to the first wireless device, a second message container that includes a second set of one or more type-specific segments, where the first type-specific segment and a second type-specific segment of the second set of one or more type-specific segments both correspond to a device type of the first wireless device. The message manager 1635 is configurable or configured to communicate one or more messages with the first wireless device in accordance with the first type-specific segment and the second type-specific segment.

In some implementations, the first message container and the second message container are transmitted via a primary channel. In some implementations, a single physical layer protocol data unit (PPDU) comprises the first message container and the second message container. In some implementations, a first physical layer protocol data unit (PPDU) comprises the first message container and a second PPDU comprises the second message container. In some implementations, the first type-specific segment, the second type-specific segment, or both, comprise an information element, a field, or both. In some implementations, the first type-specific segment comprises information to configure the device type of the first wireless device and one or more generations of device types prior to the device type, and wherein the second type-specific segment comprises information to configure the device type of the first wireless device.

In some implementations, the first message container manager 1625 is configurable or configured to transmit, in accordance with a first periodicity, a set of one or more first message containers. In some implementations, the second message container manager 1630 is configurable or configured to transmit, in accordance with a second periodicity, a set of one or more second message containers, where the second periodicity is greater than the first periodicity.

In some implementations, the first message container manager 1625 is configurable or configured to transmit, in accordance with a first periodicity, a set of one or more first message containers each including one or more common parameters. In some implementations, the second message container manager 1630 is configurable or configured to transmit, in accordance with a second periodicity, a set of one or more second message containers each including a second set of one or more type-specific parameters, where the second set of one or more type-specific parameters corresponds to the device type of the first wireless device.

In some implementations, at least the second message container includes an indication of which one or more type-specific segments are included in the at least one message container.

In some implementations, at least one type-specific segment of the second set of one or more type-specific segments includes an indication of a length of the at least one type-specific segment.

In some implementations, the first wireless device is a wireless station or a non-access point station, and the second wireless device is an access point.

Additionally, or alternatively, the wireless communication device 1600 may support wireless communications in accordance with examples as disclosed herein. The message extension container manager 1640 is configurable or configured to transmit, to a first wireless device, a message extension container that includes one or more segments, the one or more segments including a common segment with one or more common parameters and a set of one or more type-specific segments, each type-specific segment of the set of one or more type-specific segments including a respective set of one or more type-specific parameters that correspond to a respective device type of a set of multiple device types. The parameter manager 1645 is configurable or configured to communicate one or more messages with the first wireless device in accordance with the one or more common parameters and a first set of one or more type-specific parameters from a first type-specific segment from the one or more segments that corresponds to a device type of the first wireless device.

In some implementations, to support communicating the one or more messages, the parameter manager 1645 is configurable or configured to communicate the one or more messages with the first wireless device in accordance with a second set of one or more type-specific parameters from one or more second type-specific segments from the one or more segments, the one or more second type-specific segments based on the device type of the first wireless device.

In some implementations, to support transmitting the message extension container, the message extension container manager 1640 is configurable or configured to transmit the message extension container including a set of multiple frame check sequences, where each segment of the one or more segments includes a respective frame check sequence of the set of multiple frame check sequences.

In some implementations, to support receiving the message extension container, the message extension container manager 1640 is configurable or configured to transmit the message extension container including a set of multiple message integrity codes, where each segment of the one or more segments includes a respective message integrity code of the set of multiple message integrity codes.

FIG. 17 shows a flowchart illustrating an example process 1700 performable by or at a first wireless device that supports beacon extension design. The operations of the process 1700 may be implemented by a first wireless device or its components as described herein. For example, the process 1700 may be performed by a wireless communication device, such as the wireless communication device 1500 described with reference to FIG. 15, operating as or within a wireless STA. In some implementations, the process 1700 may be performed by a wireless STA, such as one of the STAs 104 described with reference to FIG. 1.

In some implementations, in block 1705, the first wireless device may receive, from a second wireless device, a first message container that includes a first set of one or more type-specific segments, a first type-specific segment of the first set of one or more type-specific segments including a first set of one or more type-specific parameters. The operations of block 1705 may be performed in accordance with examples as disclosed herein. In some implementations, aspects of the operations of block 1705 may be performed by a first message container component 1525 as described with reference to FIG. 15.

In some implementations, in block 1710, the first wireless device may receive, from the second wireless device, a second message container that includes a second set of one or more type-specific segments, where the first type-specific segment and a second type-specific segment of the second set of one or more type-specific segments both correspond to a device type of the first wireless device. The operations of block 1710 may be performed in accordance with examples as disclosed herein. In some implementations, aspects of the operations of block 1710 may be performed by a second message container component 1530 as described with reference to FIG. 15.

In some implementations, in block 1715, the first wireless device may communicate one or more messages with the second wireless device in accordance with the first type-specific segment and the second type-specific segment. The operations of block 1715 may be performed in accordance with examples as disclosed herein. In some implementations, aspects of the operations of block 1715 may be performed by a message component 1535 as described with reference to FIG. 15.

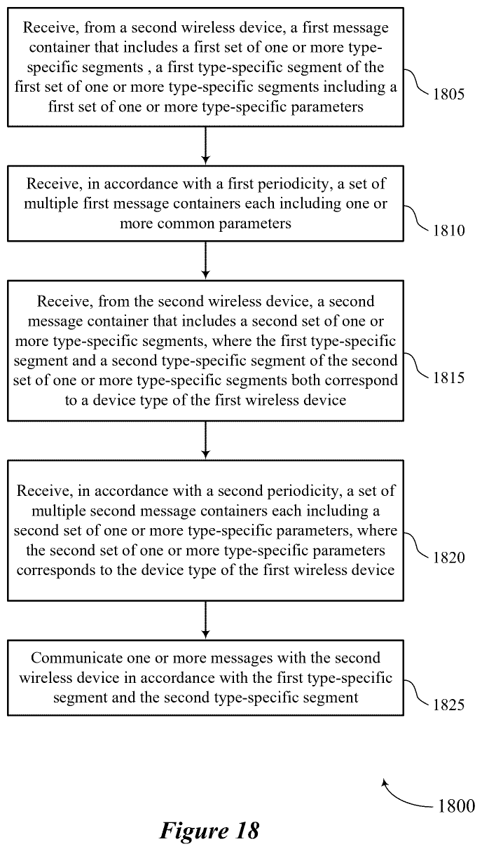

FIG. 18 shows a flowchart illustrating an example process 1800 performable by or at a first wireless device that supports beacon extension design. The operations of the process 1800 may be implemented by a first wireless device or its components as described herein. For example, the process 1800 may be performed by a wireless communication device, such as the wireless communication device 1500 described with reference to FIG. 15, operating as or within a wireless STA. In some implementations, the process 1800 may be performed by a wireless STA, such as one of the STAs 104 described with reference to FIG. 1.

In some implementations, in block 1805, the first wireless device may receive, from a second wireless device, a first message container that includes a first set of one or more type-specific segments, a first type-specific segment of the first set of one or more type-specific segments including a first set of one or more type-specific parameters. The operations of block 1805 may be performed in accordance with examples as disclosed herein. In some implementations, aspects of the operations of block 1805 may be performed by a first message container component 1525 as described with reference to FIG. 15.

In some implementations, in block 1810, the first wireless device may receive, in accordance with a first periodicity, a set of one or more first message containers each including one or more common parameters. The operations of block 1810 may be performed in accordance with examples as disclosed herein. In some implementations, aspects of the operations of block 1810 may be performed by a first message container component 1525 as described with reference to FIG. 15.

In some implementations, in block 1815, the first wireless device may receive, from the second wireless device, a second message container that includes a second set of one or more type-specific segments, where the first type-specific segment and a second type-specific segment of the second set of one or more type-specific segments both correspond to a device type of the first wireless device. The operations of block 1815 may be performed in accordance with examples as disclosed herein. In some implementations, aspects of the operations of block 1815 may be performed by a second message container component 1530 as described with reference to FIG. 15.

In some implementations, in block 1820, the first wireless device may receive, in accordance with a second periodicity, a set of one or more second message containers each including a second set of one or more type-specific parameters, where the second set of one or more type-specific parameters corresponds to the device type of the first wireless device. The operations of block 1820 may be performed in accordance with examples as disclosed herein. In some implementations, aspects of the operations of block 1820 may be performed by a second message container component 1530 as described with reference to FIG. 15.

In some implementations, in block 1825, the first wireless device may communicate one or more messages with the second wireless device in accordance with the first type-specific segment and the second type-specific segment. The operations of block 1825 may be performed in accordance with examples as disclosed herein. In some implementations, aspects of the operations of block 1825 may be performed by a message component 1535 as described with reference to FIG. 15.

FIG. 19 shows a flowchart illustrating an example process 1900 performable by or at a second wireless device that supports beacon extension design. The operations of the process 1900 may be implemented by a second wireless device or its components as described herein. For example, the process 1900 may be performed by a wireless communication device, such as the wireless communication device 1600 described with reference to FIG. 16, operating as or within a wireless AP. In some implementations, the process 1900 may be performed by a wireless AP, such as one of the APs 102 described with reference to FIG. 1.

In some implementations, in block 1905, the second wireless device may transmit, to a first wireless device, a first message container that includes a first set of one or more type-specific segments, a first type-specific segment of the first set of one or more type-specific segments including a first set of one or more type-specific parameters. The operations of block 1905 may be performed in accordance with examples as disclosed herein. In some implementations, aspects of the operations of block 1905 may be performed by a first message container manager 1625 as described with reference to FIG. 16.

In some implementations, in block 1910, the second wireless device may transmit, to the first wireless device, a second message container that includes a second set of one or more type-specific segments, where the first type-specific segment and a second type-specific segment of the second set of one or more type-specific segments both correspond to a device type of the first wireless device. The operations of block 1910 may be performed in accordance with examples as disclosed herein. In some implementations, aspects of the operations of block 1910 may be performed by a second message container manager 1630 as described with reference to FIG. 16.

In some implementations, in block 1915, the second wireless device may communicate one or more messages with the first wireless device in accordance with the first type-specific segment and the second type-specific segment. The operations of block 1915 may be performed in accordance with examples as disclosed herein. In some implementations, aspects of the operations of block 1915 may be performed by a message manager 1635 as described with reference to FIG. 16.

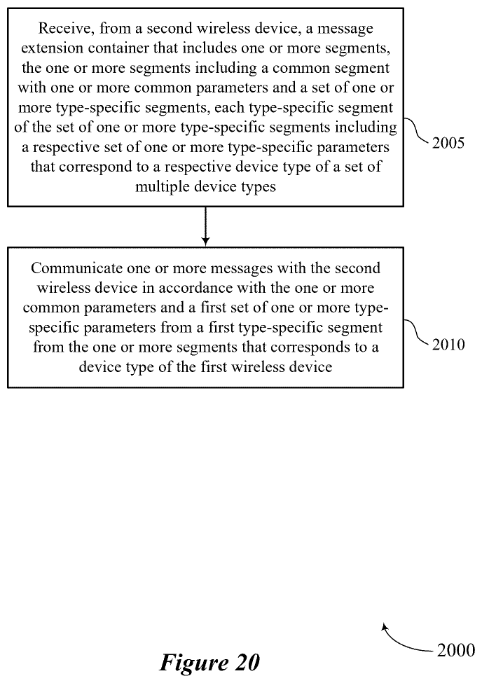

FIG. 20 shows a flowchart illustrating an example process 2000 performable by or at a first wireless device that supports beacon extension design. The operations of the process 2000 may be implemented by a first wireless device or its components as described herein. For example, the process 2000 may be performed by a wireless communication device, such as the wireless communication device 1500 described with reference to FIG. 15, operating as or within a wireless STA. In some implementations, the process 2000 may be performed by a wireless STA, such as one of the STAs 104 described with reference to FIG. 1.

In some implementations, in block 2005, the first wireless device may receive, from a second wireless device, a message extension container that includes one or more segments, the one or more segments including a common segment with one or more common parameters and a set of one or more type-specific segments, each type-specific segment of the set of one or more type-specific segments including a respective set of one or more type-specific parameters that correspond to a respective device type of a set of multiple device types. The operations of block 2005 may be performed in accordance with examples as disclosed herein. In some implementations, aspects of the operations of block 2005 may be performed by a message extension container component 1540 as described with reference to FIG. 15.

In some implementations, in block 2010, the first wireless device may communicate one or more messages with the second wireless device in accordance with the one or more common parameters and a first set of one or more type-specific parameters from a first type-specific segment from the one or more segments that corresponds to a device type of the first wireless device. The operations of block 2010 may be performed in accordance with examples as disclosed herein. In some implementations, aspects of the operations of block 2010 may be performed by a parameter component 1545 as described with reference to FIG. 15.

FIG. 21 shows a flowchart illustrating an example process 2100 performable by or at a second wireless device that supports beacon extension design. The operations of the process 2100 may be implemented by a second wireless device or its components as described herein. For example, the process 2100 may be performed by a wireless communication device, such as the wireless communication device 1600 described with reference to FIG. 16, operating as or within a wireless AP. In some implementations, the process 2100 may be performed by a wireless AP, such as one of the APs 102 described with reference to FIG. 1.

In some implementations, in block 2105, the second wireless device may transmit, to a first wireless device, a message extension container that includes one or more segments, the one or more segments including a common segment with one or more common parameters and a set of one or more type-specific segments, each type-specific segment of the set of one or more type-specific segments including a respective set of one or more type-specific parameters that correspond to a respective device type of a set of multiple device types. The operations of block 2105 may be performed in accordance with examples as disclosed herein. In some implementations, aspects of the operations of block 2105 may be performed by a message extension container manager 1640 as described with reference to FIG. 16.

In some implementations, in block 2110, the second wireless device may communicate one or more messages with the first wireless device in accordance with the one or more common parameters and a first set of one or more type-specific parameters from a first type-specific segment from the one or more segments that corresponds to a device type of the first wireless device. The operations of block 2110 may be performed in accordance with examples as disclosed herein. In some implementations, aspects of the operations of block 2110 may be performed by a parameter manager 1645 as described with reference to FIG. 16.

Implementation examples are described in the following numbered clauses:
Aspect 1: A method for wireless communications at a first wireless device, including: receiving, from a second wireless device, a first message container that includes a first set of one or more type-specific segments, a first type-specific segment of the first set of one or more type-specific segments including a first set of one or more type-specific parameters; receiving, from the second wireless device, a second message container that includes a second set of one or more type-specific segments, where the first type-specific segment and a second type-specific segment of the second set of one or more type-specific segments both correspond to a device type of the first wireless device; and communicating one or more messages with the second wireless device in accordance with the first type-specific segment and the second type-specific segment.
Aspect 2: The method of aspect 1, wherein the first message container and the second message container are received via a primary channel.
Aspect 3: The method of any of aspects 1 through 2, wherein a single physical layer protocol data unit (PPDU) comprises the first message container and the second message container.
Aspect 4: The method of any of aspects 1 through 3, wherein a first physical layer protocol data unit (PPDU) comprises the first message container and a second PPDU comprises the second message container.
Aspect 5: The method of any of aspects 1 through 4, wherein the first type-specific segment comprises information to configure the device type of the first wireless device and one or more generations of device types prior to the device type, and the second type-specific segment comprises information to configure the device type of the first wireless device.
Aspect 6: The method of any of aspects 1 through 5, wherein the second type-specific segment indicates an update to at least one parameter of the first set of one or more type-specific parameters.
Aspect 7: The method of any of aspects 1 through 6, wherein the first type-specific segment, the second type-specific segment, or both, comprise an information element, a field, or both.
Aspect 8: The method of any of aspects 1 through 7, wherein the second set of one or more type-specific segments included in the second message container comprises a type-specific segment having a value that has changed since reception of the first message container.
Aspect 9: The method of any of aspects 1 through 8, wherein receiving the first message container further comprises: receiving the first message container including an indication that indicates that at least a first portion of the first set of one or more type-specific parameters is included in the first message container, that at least a second portion of the first set of one or more type-specific parameters is included in the second message container, or both, wherein the indication is based at least in part on the device type of the first wireless device.
Aspect 10: The method of any of aspects 1 through 9, further comprising: receiving, in accordance with a first periodicity, one or more first message containers; and receiving, in accordance with a second periodicity, one or more second message containers, wherein the second periodicity is greater than the first periodicity.
Aspect 11: The method of any of aspects 1 through 10, further comprising: receiving, in accordance with a first periodicity, one or more first message containers each comprising one or more common parameters; and receiving, in accordance with a second periodicity, one or more second message containers each comprising a second set of one or more type-specific parameters, wherein the second set of one or more type-specific parameters corresponds to the device type of the first wireless device.
Aspect 12: The method of any of aspects 1 through 11, wherein the one or more messages are communicated with the second wireless device in accordance with one or more common parameters and the second set of one or more type-specific parameters.
Aspect 13: The method of any of aspects 1 through 12, wherein at the second message containers includes an indication of which one or more type-specific segments are included in the at least one message container.
Aspect 14: The method of any of aspects 1 through 13, wherein receiving the second message container further comprises: receiving the second message container comprising a plurality of frame check sequences, wherein each segment of the second set of one or more type-specific segments includes a respective frame check sequence of the plurality of frame check sequences. In some implementations, each respective frame check sequence is used to validate one or more previous segments of the second set of one or more type-specific segments.
Aspect 15: The method of any of aspects 1 through 14, wherein receiving the second message container further comprises: receiving the second message container comprising a plurality of message integrity codes, wherein each segment of the second set of one or more type-specific segments includes a respective message integrity code of the plurality of message integrity codes. In some implementations, each respective message integrity code is used to validate one or more previous segments of the second set of one or more type-specific segments, and where each respective message integrity code corresponds to a first set of security parameters that are stronger than a second set of security parameters of a message integrity code of one or more common segments.
Aspect 16: The method of any of aspects 1 through 15, wherein the second message container is a type-specific management frame which includes at least one of a first traffic indicator, a first timing synchronization function, an indication of one or more supported device types, a type-specific parameter update, a message integrity code, a frame check sequence, or any combination thereof, the type-specific management frame corresponds to the device type of the first wireless device.
Aspect 17: The method of aspect 16, wherein the first message container includes a second traffic indicator having a different format, a different encoding, or a different interpretation than the first traffic indicator, a second timing synchronization function having a different format, a different encoding, or a different interpretation than the first timing synchronization function, or both. In some implementations, at least one operation that does not apply to one or more fields, elements, or both, in the first message container that applies to one or more fields, elements, or both, in the second message container.
Aspect 18: The method of any of aspects 1 through 17, wherein at least one type-specific segment of the second set of one or more type-specific segments includes an indication of a length of the at least one type-specific segment.
Aspect 19: The method of any of aspects 1 through 18, wherein the first message container is a beacon frame and the second message container is a beacon extension frame.
Aspect 20: The method of any of aspects 1 through 19, wherein the first message container is a beacon extension frame and the second message container is a beacon frame.
Aspect 21: A method for wireless communications at a second wireless device, comprising: transmitting, to a first wireless device, a first message container that comprises a first set of one or more type-specific segments, a first type-specific segment of the first set of one or more type-specific segments including a first set of one or more type-specific parameters; transmitting, to the first wireless device, a second message container that comprises a second set of one or more type-specific segments, wherein the first type-specific segment and a second type-specific segment of the second set of one or more type-specific segments both correspond to a device type of the first wireless device; and communicating one or more messages with the first wireless device in accordance with the first type-specific segment and the second type-specific segment.
Aspect 22: The method of aspect 21, wherein the first message container and the second message container are received via a primary channel.
Aspect 23: The method of any of aspects 21 through 22, wherein a single physical layer protocol data unit (PPDU) comprises the first message container and the second message container.
Aspect 24: The method of any of aspects 21 through 23, wherein a first physical layer protocol data unit (PPDU) comprises the first message container and a second PPDU comprises the second message container.
Aspect 25: The method of any of aspects 21 through 24, wherein the first type-specific segment comprises information to configure the device type of the first wireless device and one or more generations of device types prior to the device type, and the second type-specific segment comprises information to configure the device type of the first wireless device.
Aspect 26: The method of any of aspects 21 through 25, wherein the second type-specific segment indicates an update to at least one parameter of the first set of one or more type-specific parameters.
Aspect 27: The method of any of aspects 21 through 26, wherein the first type-specific segment, the second type-specific segment, or both, comprise an information element, a field, or both.
Aspect 28: The method of any of aspects 21 through 27, wherein the second set of one or more type-specific segments included in the second message container comprises a type-specific segment having a value that has changed since transmission of the first message container.
Aspect 29: The method of any of aspects 21 through 28, further comprising: transmitting, in accordance with a first periodicity, one or more first message containers; and transmitting, in accordance with a second periodicity, one or more second message containers, wherein the second periodicity is greater than the first periodicity.
Aspect 30: The method of any of aspects 21 through 29, further comprising: transmitting, in accordance with a first periodicity, one or more first message containers each comprising one or more common parameters; and transmitting, in accordance with a second periodicity, one or more second message containers each comprising a second set of one or more type-specific parameters, wherein the second set of one or more type-specific parameters corresponds to the device type of the first wireless device.
Aspect 31: The method of aspect 30, wherein at least one message container of the one or more second message containers includes an indication of which one or more type-specific segments are included in the at least one message container. In some examples, at least one type-specific segment of the second set of one or more type-specific segments includes a bitmap indicating a set of device types supported by the second wireless device.
Aspect 32: The method of any of aspects 21 through 31, wherein at least one type-specific segment of the second set of one or more type-specific segments includes an indication of a length of the at least one type-specific segment.
Aspect 33: The method of any of aspects 21 through 32, wherein the first wireless device is a wireless station or a non-access point station, and wherein the second wireless device is an access point.
Aspect 34: A method for wireless communications at a first wireless device, comprising: receiving, from a second wireless device, a message extension container that comprises one or more segments, the one or more segments including a common segment with one or more common parameters and a set of one or more type-specific segments, each type-specific segment of the set of one or more type-specific segments comprising a respective set of one or more type-specific parameters that correspond to a respective device type of a plurality of device types; and communicating one or more messages with the second wireless device in accordance with the one or more common parameters and a first set of one or more type-specific parameters from a first type-specific segment from the one or more segments that corresponds to a device type of the first wireless device.
Aspect 35: The method of aspect 34, wherein communicating the one or more messages further comprises: communicating the one or more messages with the access point in accordance with a second set of one or more type-specific parameters from one or more second type-specific segments from the one or more segments, the one or more second type-specific segments based at least in part on the device type of the first wireless device.
Aspect 36: The method of any of aspects 34 through 35, wherein receiving the message extension container further comprises: receiving the message extension container comprising a plurality of frame check sequences, wherein each segment of the one or more segments includes a respective frame check sequence of the plurality of frame check sequences.
Aspect 37: The method of any of aspects 34 through 36, wherein receiving the message extension container further comprises: receiving the message extension container comprising a plurality of message integrity codes, wherein each segment of the one or more segments includes a respective message integrity code of the plurality of message integrity codes.
Aspect 38: The method of any of aspects 34 through 37, wherein the message extension container is a physical layer protocol data unit that comprises a plurality of beacon extension frames.
Aspect 39: The method of any of aspects 34 through 38, wherein the message extension container is a beacon extension frame.
Aspect 40: A method for wireless communications at a second wireless device, comprising: transmitting, to a first wireless device, a message extension container that comprises one or more segments, the one or more segments including a common segment with one or more common parameters and a set of one or more type-specific segments, each type-specific segment of the set of one or more type-specific segments comprising a respective set of one or more type-specific parameters that correspond to a respective device type of a plurality of device types; and communicating one or more messages with the first wireless device in accordance with the one or more common parameters and a first set of one or more type-specific parameters from a first type-specific segment from the one or more segments that corresponds to a device type of the first wireless device.
Aspect 41: The method of aspect 40, wherein communicating the one or more messages further comprises: communicating the one or more messages with the first wireless device in accordance with a second set of one or more type-specific parameters from one or more second type-specific segments from the one or more segments, the one or more second type-specific segments based at least in part on the device type of the first wireless device.
Aspect 42: The method of any of aspects 40 through 41, wherein transmitting the message extension container further comprises: transmitting the message extension container comprising a plurality of frame check sequences, wherein each segment of the one or more segments includes a respective frame check sequence of the plurality of frame check sequences.
Aspect 43: The method of any of aspects 40 through 42, wherein receiving the message extension container further comprises: transmitting the message extension container comprising a plurality of message integrity codes, wherein each segment of the one or more segments includes a respective message integrity code of the plurality of message integrity codes.
Aspect 44: A first wireless device for wireless communications, comprising one or more memories storing processor-executable code, and one or more processors coupled with the one or more memories and individually or collectively operable to execute the code to cause the first wireless device to perform a method of any of aspects 1 through 20.
Aspect 45: A first wireless device for wireless communications, comprising at least one means for performing a method of any of aspects 1 through 20.
Aspect 46: A non-transitory computer-readable medium storing code for wireless communications, the code comprising instructions executable by one or more processors to perform a method of any of aspects 1 through 20.
Aspect 47: A method for wireless communications, comprising causing a first wireless device to perform a method of any of aspects 1 through 20.
Aspect 48: A second wireless device for wireless communications, comprising one or more memories storing processor-executable code, and one or more processors coupled with the one or more memories and individually or collectively operable to execute the code to cause the second wireless device to perform a method of any of aspects 21 through 33.
Aspect 49: A second wireless device for wireless communications, comprising at least one means for performing a method of any of aspects 21 through 33.
Aspect 50: A non-transitory computer-readable medium storing code for wireless communications, the code comprising instructions executable by one or more processors to perform a method of any of aspects 21 through 33.
Aspect 51: A method for wireless communications, comprising causing a first wireless device to perform a method of any of aspects 21 through 33.
Aspect 52: A first wireless device for wireless communications, comprising one or more memories storing processor-executable code, and one or more processors coupled with the one or more memories and individually or collectively operable to execute the code to cause the first wireless device to perform a method of any of aspects 34 through 39.
Aspect 53: A first wireless device for wireless communications, comprising at least one means for performing a method of any of aspects 34 through 39.
Aspect 54: A non-transitory computer-readable medium storing code for wireless communications, the code comprising instructions executable by one or more processors to perform a method of any of aspects 34 through 39.
Aspect 55: A method for wireless communications, comprising causing a first wireless device to perform a method of any of aspects 34 through 39.
Aspect 56: A second wireless device for wireless communications, comprising one or more memories storing processor-executable code, and one or more processors coupled with the one or more memories and individually or collectively operable to execute the code to cause the second wireless device to perform a method of any of aspects 40 through 43.
Aspect 57: A second wireless device for wireless communications, comprising at least one means for performing a method of any of aspects 40 through 43.
Aspect 58: A non-transitory computer-readable medium storing code for wireless communications, the code comprising instructions executable by one or more processors to perform a method of any of aspects 40 through 43.
Aspect 47: A method for wireless communications, comprising causing a first wireless device to perform a method of any of aspects 40 through 43.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,” or the equivalent in context, whatever it is that is “based on ‘a, “ ” or “based at least in part on ‘a,” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the essence or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless device, comprising:
a processing system that includes processor circuitry and memory circuitry that stores code, the processing system configured to cause the first wireless device to:
receive, from a second wireless device, a first message container that comprises a first set of one or more type-specific segments, a first type-specific segment of the first set of one or more type-specific segments including a first set of one or more type-specific parameters;
receive, from the second wireless device, a second message container that comprises a second set of one or more type-specific segments, wherein the first type-specific segment and a second type-specific segment of the second set of one or more type-specific segments both correspond to a device type of the first wireless device; and
communicate one or more messages with the second wireless device in accordance with the first type-specific segment and the second type-specific segment.

2. The first wireless device of claim 1, wherein the first message container and the second message container are received via a primary channel.

3. The first wireless device of claim 1, wherein a single physical layer protocol data unit (PPDU) comprises the first message container and the second message container.

4. The first wireless device of claim 1, wherein a first physical layer protocol data unit (PPDU) comprises the first message container and a second PPDU comprises the second message container.

5. The first wireless device of claim 1, wherein the first type-specific segment comprises information to configure the device type of the first wireless device and one or more generations of device types prior to the device type, and wherein the second type-specific segment comprises information to configure the device type of the first wireless device.

6. The first wireless device of claim 1, wherein the second type-specific segment indicates an update to at least one parameter of the first set of one or more type-specific parameters.

7. The first wireless device of claim 1, wherein the first type-specific segment, the second type-specific segment, or both, comprise an information element, a field, or both.

8. The first wireless device of claim 1, wherein the second set of one or more type-specific segments included in the second message container comprises a type-specific segment having a value that has changed since reception of the first message container.

9. The first wireless device of claim 1, wherein, to receive the first message container, the processing system is further configured to cause the first wireless device to:
receive the first message container including an indication that indicates that at least a first portion of the first set of one or more type-specific parameters is included in the first message container, that at least a second portion of the first set of one or more type-specific parameters is included in the second message container, or both, wherein the indication is based at least in part on the device type of the first wireless device.

10. The first wireless device of claim 1, wherein the processing system is further configured to cause the first wireless device to:
receive, in accordance with a first periodicity, one or more first message containers; and
receive, in accordance with a second periodicity, one or more second message containers, wherein the second periodicity is greater than the first periodicity.

11. The first wireless device of claim 1, wherein the processing system is further configured to cause the first wireless device to:
receive, in accordance with a first periodicity, one or more first message containers each comprising one or more common parameters; and
receive, in accordance with a second periodicity, one or more second message containers each comprising a second set of one or more type-specific parameters, wherein the second set of one or more type-specific parameters corresponds to the device type of the first wireless device.

12. The first wireless device of claim 1, wherein the one or more messages are communicated with the second wireless device in accordance with one or more common parameters and the second set of one or more type-specific segments.

13. The first wireless device of claim 1, wherein at least the second message container includes an indication of which one or more type-specific segments are included in the first message container.

14. The first wireless device of claim 1, wherein, to receive the second message container, the processing system is further configured to cause the first wireless device to:
receive the second message container comprising a plurality of frame check sequences, wherein each segment of the second set of one or more type-specific segments includes a respective frame check sequence of the plurality of frame check sequences.

15. The first wireless device of claim 1, wherein, to receive the second message container, the processing system is further configured to cause the first wireless device to:
receive the second message container comprising a plurality of message integrity codes, wherein each segment of the second set of one or more type-specific segments includes a respective message integrity code of the plurality of message integrity codes.

16. The first wireless device of claim 1, wherein:
the second message container is a type-specific management frame which includes at least one of a first traffic indicator, a first timing synchronization function, an indication of one or more supported device types, a type-specific parameter update, a message integrity code, a frame check sequence, or any combination thereof, wherein the type-specific management frame corresponds to the device type of the first wireless device.

17. The first wireless device of claim 16, wherein the first message container includes a second traffic indicator having a different format than the first traffic indicator, a different encoding than the first traffic indicator, or a different interpretation than the first traffic indicator, a second timing synchronization function having a different format than the first timing synchronization function, a different encoding than the first timing synchronization function, or a different interpretation than the first timing synchronization function, or both.

18. The first wireless device of claim 1, wherein at least one type-specific segment of the second set of one or more type-specific segments includes an indication of a length of the at least one type-specific segment.

19. The first wireless device of claim 1, wherein the first message container is a beacon frame and the second message container is one of a beacon extension frame, a probe response frame, or a management frame.

20. The first wireless device of claim 1, wherein the first message container is one of a beacon extension frame, a probe response frame, or a management frame, and the second message container is a beacon frame.

21. A second wireless device, comprising:
a processing system that includes processor circuitry and memory circuitry that stores code, the processing system configured to cause the second wireless device to:
transmit, to a first wireless device, a first message container that comprises a first set of one or more type-specific segments, a first type-specific segment of the first set of one or more type-specific segments including a first set of one or more type-specific parameters;
transmit, to the first wireless device, a second message container that comprises a second set of one or more type-specific segments, wherein the first type-specific segment and a second type-specific segment of the second set of one or more type-specific segments both correspond to a device type of the first wireless device; and
communicate one or more messages with the first wireless device in accordance with the first type-specific segment and the second type-specific segment.

22. The second wireless device of claim 21, wherein the first message container and the second message container are transmitted via a primary channel.

23. The second wireless device of claim 21, wherein a single physical layer protocol data unit (PPDU) comprises the first message container and the second message container.

24. The second wireless device of claim 21, wherein a first physical layer protocol data unit (PPDU) comprises the first message container and a second PPDU comprises the second message container.

25. The second wireless device of claim 21, wherein the first type-specific segment comprises information to configure the device type of the first wireless device and one or more generations of device types prior to the device type, and wherein the second type-specific segment comprises information to configure the device type of the first wireless device.

26. The second wireless device of claim 21, wherein the second type-specific segment indicates an update to at least one parameter of the first set of one or more type-specific parameters.

27. The second wireless device of claim 21, wherein the first type-specific segment, the second type-specific segment, or both, comprise an information element, a field, or both.

28. The second wireless device of claim 21, wherein the second set of one or more type-specific segments included in the second message container comprises a type-specific segment having a value that has changed since transmission of the first message container.

29. The second wireless device of claim 21, wherein the processing system is further configured to cause the second wireless device to:
transmit, in accordance with a first periodicity, one or more first message containers; and
transmit, in accordance with a second periodicity, one or more second message containers, wherein the second periodicity is greater than the first periodicity.

30. The second wireless device of claim 21, wherein the processing system is further configured to cause the second wireless device to:
transmit, in accordance with a first periodicity, one or more first message containers each comprising one or more common parameters; and
transmit, in accordance with a second periodicity, one or more second message containers each comprising a second set of one or more type-specific parameters, wherein the second set of one or more type-specific parameters corresponds to the device type of the first wireless device.

31. The second wireless device of claim 30, wherein at least one message container of the one or more second message containers includes an indication of which one or more type-specific segments are included in the at least one message container.

32. The second wireless device of claim 21, wherein at least one type-specific segment of the second set of one or more type-specific segments includes an indication of a length of the at least one type-specific segment.

33. The second wireless device of claim 21, wherein the first wireless device is a wireless station or a non-access point station, and the second wireless device is an access point.

34. A first wireless device, comprising:
a processing system that includes processor circuitry and memory circuitry that stores code, the processing system configured to cause the first wireless device to:
receive, from a second wireless device, a message extension container that comprises one or more segments, the one or more segments including a common segment with one or more common parameters and a set of one or more type-specific segments, each type-specific segment of the set of one or more type-specific segments comprising a respective set of one or more type-specific parameters that correspond to a respective device type of a plurality of device types; and
communicate one or more messages with the second wireless device in accordance with the one or more common parameters and a first set of one or more type-specific parameters from a first type-specific segment from the one or more segments that corresponds to a device type of the first wireless device.

35. The first wireless device of claim 34, wherein, to communicate the one or more messages, the processing system is further configured to cause the first wireless device to:
communicate the one or more messages with the second wireless device in accordance with a second set of one or more type-specific parameters from one or more second type-specific segments from the one or more segments, the one or more second type-specific segments based at least in part on the device type of the first wireless device.

36. The first wireless device of claim 34, wherein, to receive the message extension container, the processing system is further configured to cause the first wireless device to:
receive the message extension container comprising a plurality of frame check sequences, wherein each segment of the one or more segments includes a respective frame check sequence of the plurality of frame check sequences.

37. The first wireless device of claim 34, wherein, to receive the message extension container, the processing system is further configured to cause the first wireless device to:
receive the message extension container comprising a plurality of message integrity codes, wherein each segment of the one or more segments includes a respective message integrity code of the plurality of message integrity codes.

38. The first wireless device of claim 34, wherein the message extension container is a physical layer protocol data unit that comprises a plurality of beacon extension frames.

39. The first wireless device of claim 34, wherein the message extension container is one of a beacon extension frame, a probe response frame, or a management frame.

40. A second wireless device, comprising:
a processing system that includes processor circuitry and memory circuitry that stores code, the processing system configured to cause the second wireless device to:
transmit, to a first wireless device, a message extension container that comprises one or more segments, the one or more segments including a common segment with one or more common parameters and a set of one or more type-specific segments, each type-specific segment of the set of one or more type-specific segments comprising a respective set of one or more type-specific parameters that correspond to a respective device type of a plurality of device types; and
communicate one or more messages with the first wireless device in accordance with the one or more common parameters and a first set of one or more type-specific parameters from a first type-specific segment from the one or more segments that corresponds to a device type of the first wireless device.

41. The second wireless device of claim 40, wherein, to communicate the one or more messages, the processing system is further configured to cause the second wireless device to:
communicate the one or more messages with the first wireless device in accordance with a second set of one or more type-specific parameters from one or more second type-specific segments from the one or more segments, the one or more second type-specific segments based at least in part on the device type of the first wireless device.

42. The second wireless device of claim 40, wherein, to transmit the message extension container, the processing system is further configured to cause the second wireless device to:
transmit the message extension container comprising a plurality of frame check sequences, wherein each segment of the one or more segments includes a respective frame check sequence of the plurality of frame check sequences.

43. The second wireless device of claim 40, wherein, to receive the message extension container, the processing system is further configured to cause the second wireless device to:
transmit the message extension container comprising a plurality of message integrity codes, wherein each segment of the one or more segments includes a respective message integrity code of the plurality of message integrity codes.
